(19) United States
(12) Patent Application Publication
(10) Pub. No.: US 2014/0204828 A1
(43) Pub. Date: Jul. 24, 2014

(54) METHOD AND APPARATUS FOR MULTICAST AND BROADCAST SERVICE MANAGEMENT

(71) Applicant: WI-LAN, INC., Ottawa (CA)

(72) Inventors: Dennis P. Connors, San Diego, CA (US); Huei-Jiun Ju, San Diego, CA (US); Keerthi S. Govind, San Diego, CA (US); Sina Zahedi, San Diego, CA (US); Gene Marsh, San Diego, CA (US)

(73) Assignee: WI-LAN, INC., Ottawa (CA)

(21) Appl. No.: 14/219,618

(22) Filed: Mar. 19, 2014

Related U.S. Application Data
(63) Continuation-in-part of application No. 11/963,504, filed on Dec. 21, 2007, now Pat. No. 8,705,493.
Application No. 11/963,504 is a continuation-in-part of application No. 12/104,299, filed on Apr. 16, 2008, now Pat. No. 8,711,833.
(60) Provisional application No. 60/971,837, filed on Sep. 12, 2007.
(60) Provisional application No. 60/953,452, filed on Aug. 1, 2007.
(60) Provisional application No. 60/913,172, filed on Apr. 20, 2007.
(60) Provisional application No. 60/912,661, filed on Apr. 18, 2007.
(60) Provisional application No. 60/971,837, filed on Sep. 12, 2007.
(60) Provisional application No. 60/953,452, filed on Aug. 1, 2007.
(60) Provisional application No. 60/912,661, filed on Apr. 18, 2007.

(51) Int. Cl. H04L 5/00; H04W 56/00

(52) U.S. Cl. CPC H04L 5/0032; H04W 56/001
USPC 370/312

(57) ABSTRACT

Methods, apparatuses, and systems for announcing services available in a macro-diversity region of a data frame broadcast by a plurality of base stations in a single frequency network to a plurality of subscriber stations, including providing to the client station broadcast service identification and type of service information. Other functions include data content synchronization, broadcasting and forwarding of multicast and broadcast services (MBS) packets, and MBS session control.

### RELATED APPLICATIONS

This application is a continuation-in-part of U.S. patent application Ser. No. 11/963,504, filed Dec. 21, 2007, which claims the benefit of U.S. Provisional Patent Application Ser. No. 60/971,837 filed Sep. 12, 2007, U.S. Provisional Patent Application Ser. No. 60/953,452, filed Aug. 1, 2007, U.S. Provisional Patent Application Ser. No. 60/913,172, filed Apr. 20, 2007, and U.S. Provisional Patent Application Ser. No. 60/912,661, filed Apr. 18, 2007, which are incorporated by reference as if fully set forth. This application is also a continuation-in-part of U.S. patent application Ser. No. 12/104,299, filed Apr. 16, 2008, which claims the benefit of U.S. Provisional Patent Application Ser. No. 60/971,837 filed Sep. 12, 2007, U.S. Provisional Patent Application Ser. No. 60/953,452, filed Aug. 1, 2007, and U.S. Provisional Patent Application Ser. No. 60/912,661, filed Apr. 18, 2007, which are incorporated by reference as if fully set forth.

### BACKGROUND

1. Field

This disclosure relates generally to a wireless communication system and in particular to a wireless broadcast communication system.

2. Background

Wireless communication networks typically have a plurality of servicing base stations which receive and transmit signals to users' devices within the service area of the respective base stations. Communication between a user and their respective base station is maintained as a user moves about the network service area by handing off the user from one base station to another.

Many new services are being offered to customers of wireless communication carriers. One such service is providing customers with multimedia content via the wireless communication network. For example, it is desired to provide audio/video content to customers as they move about the network.

Providing multimedia content via wireless communication networks presents several challenges. For example in broadcast multimedia content to client stations, it is desirable for the transmission of content data to be synchronized at multiple base stations in a network.

Therefore, there is a need for improved systems, apparatus, and techniques for receiving broadcasting content, to ensure that data is smoothly transmitted to end users.

In another example, multimedia content is typically broadcast to users that want the content. A user that desires to receive the broadcast content, decodes the broadcasted content and examines the content available to determine if there is content that is of interest to the user. In order to determine if the broadcasted content includes content of interest to the user, the user in current systems needs to decode the broadcast content and examine it to determine if it contains the content of interest to the user. Decoding the broadcast content consumes resources of the user's device. These resources may not be efficiently used if it turns out that there is not any content of interest in the broadcasted content.

Therefore, there is a need for improved systems, apparatus, and techniques for receiving broadcasting content, such as multimedia content, by users in a wireless communication network.

### SUMMARY

The present disclosure includes methods, apparatuses, and systems as described in the written description and claims. In one embodiment, a macro-diversity region control module for generating and synchronizing a macro-diversity region transmitted by base stations in a network includes a buffer that may be part of the macro-diversity region control module or may be external to but coupled to the macro-diversity region control module. The macro-diversity region control module can also have a receiving module, a controller module and a communication module. The buffer may be coupled to the receiving module and configured to receive and store content data. The receiving module may be coupled to the controller module and configured to receive a plurality of packets of content data from the buffer. In one embodiment, the controller module may be configured to generate a macro-diversity region data that includes at least one packet of the plurality of packets of content data. The frame offset can be expressed as a number of frames after (or before) the time reference. The combination of the time reference and the frame offset of each macro-diversity frame identify the base station transmission frame that will include the macro-diversity region data for each of the base stations.

The controller module may also generate macro-diversity region control information that includes the time reference and frame offset information. Thus the macro-diversity region control information may be configured to synchronize the transmission of the macro-diversity region data at the base stations. In some embodiments the control information may include a modulation and coding scheme selection information to use in transmitting the macro-diversity region at the base stations. In other embodiments the control information may also include zone switch parameters where the zone switch parameters refer to parameters that determine the location and characteristics of the macro-diversity region in a frame, for example, the base station transmission frame. An example of a zone switch parameter includes a symbol offset to indicate an offset from the start of the base station transmission frame to identify a location for the macro-diversity region data in the base station transmission frame. The macro-diversity region control module may use a configuration file (described below) to determine the zone switch parameters. In some embodiments the control information including the modulation and coding scheme and the zone switch parameters may be configured to ensure that the macro-diversity region is broadcast by each of the base stations using a common waveform.

The communication module may be coupled to the controller module, to communicate a macro-diversity region message that includes the macro-diversity region data and the macro-diversity region control information to the base stations. The controller module may also be configured to determine the size of the macro-diversity region data, the location of the macro-diversity region, an allocation of content data to be broadcast in the macro-diversity region and to determine a broadcast map detailing the structure of the macro-diversity region data. In one embodiment, the time reference may be expressed in coordinated universal time (UTC).

In other embodiments, a base station may include receiving module and a transmitting module. The receiving module may be configured to receive from a central entity, for example macro-diversity region control module, a macro-diversity region message that includes a macro-diversity region data having at least one packet of content data and the macro diversity region control information. The received macro-diversity region control information may include a time reference and frame offset information. The combination of the time reference and the frame offset of each macro-diversity frame may identify the base station transmission frame that will include the macro-diversity region data for each of the base stations. Thus the transmitting module may be configured to transmit the base station transmission frame in synchronization with the transmission of the base station transmission frames of other base stations in a network, for example Single Frequency Network (SFN), in response to at least a portion of the macro-diversity region control information.

In some embodiments, a method of synchronizing a macro-diversity region transmitted by a base station in a network may be implemented in the macro-diversity region control module. In one embodiment the method includes receiving a plurality of packets of content data that may be provided by content providers or content sources. A macro-diversity region data including at least one packet of the plurality of packets of content data may be generated at the macro-diversity region control module. The macro-diversity region control module may also generate macro-diversity region control information including a time reference and frame offset information. The time reference information may be expressed in UTC time. The combination of the time reference and the frame offset of each macro-diversity frame may identify the base station transmission frame that will include the macro-diversity region data for each of the base stations. Thus the macro-diversity region control information may be configured to synchronize the transmission of the macro-diversity region data at the base stations. A macro-diversity region message that includes the macro-diversity region data and the macro-diversity region control information may be communicated to a plurality of base stations. In some embodiments the macro-diversity region control information may include a symbol offset to indicate an offset from the start of the base station transmission frame to identify a location for the macro-diversity region data in the base station transmission frame.

In another embodiment a method of synchronizing a macro-diversity region transmitted by a base station in a network may be implemented at a base station. In one embodiment a plurality of base stations receive the macro-diversity region message that includes a macro-diversity region data having at least one packet of content data and macro diversity region control information. The macro-diversity region control information may include a time reference and frame offset information. The combination of the time reference and the frame offset of each macro-diversity frame may identify the base station transmission frame that will include the macro-diversity region data for each of the base stations. In response to at least a portion of the macro-diversity region control the plurality of base stations synchronously transmit the base station transmission frame in accordance with the macro-diversity region control information.

In another embodiment, a method of broadcasting content data to a plurality of client stations includes receiving information regarding a macro-diversity region in which at least one packet comprising content data is allocated. Generating a management message identifying the content data allocated to the macro-diversity region. Transmitting a data frame comprising the macro-diversity region and a data region, wherein the management message is included in the data region of the data frame.

The management message can include a broadcast channel identifier (CID) that identifies a broadcast service to which the content data belongs. The management message can include a broadcast service field. Generating a management message can also include generating a management message in which information regarding an encoding used in encoding the content data is included in the broadcast service field. At least one packet comprising content data for each of a plurality of different content channels can be allocated to the macro-diversity region, and wherein generating a management message further comprises generating a management message in which information for identifying each of the different content channels can be included in the broadcast service field. The data frame can be an orthogonal frequency division multiple access (OFDMA) frame.

In one embodiment, the data region and the macro-diversity region of the data frame can be transmitted using different modulation and coding schemes. A map message can be generated for transmission in the macro-diversity region of the data frame wherein the map message comprises the broadcast channel identifier identifying the content data. In another embodiment, the plurality of client stations can be included in a single frequency network, and wherein transmitting the management message in a data region of the data frame includes transmitting, by a base station in the single frequency network, a data frame comprising the macro-diversity region and the data region including the management message, wherein the transmission of the macro-diversity region by the base station is synchronized with a transmission of a macro-diversity region by at least one other base station in the single frequency network.

In one embodiment, a method for identifying content data in a macro-diversity region of a data frame, the data frame comprising at least a data region and a macro-diversity region, includes receiving the data frame. Decoding a management message in the data region, wherein the management message includes information identifying content data available in the macro-diversity region of the data frame. Determining whether to decode at least a portion of the macro-diversity region of the data frame based on the information identifying the content data in the management message Decoding at least a portion of the macro-diversity region to obtain content data if it is determined to decode the at least a portion of the macro-diversity region. Providing the decoded content data for presentation to a user.

The formation identifying the content data in the management message can include a broadcast channel identifier (CID) that identifies a broadcast service to which the content data belongs. The management message can include a broadcast service field. Also, information identifying the content data in the management message can include information regarding an encoding used in encoding the content data stored in the broadcast service field. The content data in the macro-diversity region can include content data for each of a plurality of different content channels, wherein the information identifying the content data in the management message comprises information stored in the broadcast service field for identifying each of the different content channels. Receiving the data frame can include receiving an orthogonal frequency division multiple access (OFDMA) frame. The data region and the macro-diversity region of the received data frame can be encoded using different modulation and coding schemes. The macro-diversity region of the received data frame can include a map that includes a field storing a broadcast channel identifier identifying the content data.

In one embodiment of a broadcast system for use in broadcasting content data to a plurality of client stations using a data frame, the data frame comprising at least a data region and a macro-diversity region, the system includes a first interface configured to receive information regarding a macro-diversity region comprising at least one packet comprising content data. There is also controller configured to generate a management message that includes information identifying the content data allocated to the macro-diversity region, wherein the management message is for transmission in the data region of the data frame. The system also includes a transmitter configured to transmit the management message and the content data, wherein the management message is transmitted in the data region of the data frame and the content data in the macro-diversity region of the data frame.

The management message can include a broadcast channel identifier (CID) that identifies a broadcast service to which the content data belongs. The management message can also include a broadcast service field. The controller can be configured to include information regarding an encoding used in encoding the content data in the broadcast service field. The controller can also be configured to include in the broadcast service field information identifying each of a plurality of different content channels allocated to the macro-diversity region. The data frame can be an orthogonal frequency division multiple access (OFDMA) data frame. The macro-diversity region of the data frame can include a map message comprising the broadcast channel identifier identifying the content data.

In one embodiment of a client station that receives services broadcast in a data frame, the data frame comprising at least a data region and a macro-diversity region, the client station includes a receiver configured to receive the data frame. The client station also includes a decoder configured to decode a management message in the data region of the data frame, wherein the management message identifies content data included in the macro-diversity region of the data frame. A processor is included that is configured to determine whether to decode at least a portion of the macro-diversity region based on the information identifying the content data and to provide an instruction to the decoder regarding whether to decode the macro-diversity region based on the determination, wherein the decoder is further configured to decode the at least a portion of the macro-diversity region based on receipt of the instruction from the processor.

The management message can include a broadcast channel identifier (CID) that identifies a broadcast service to which the content data belongs. The management message can also include a broadcast service field. The decoder can be configured to obtain, from the broadcast service field, information regarding an encoding used in encoding the content data. Also, the decoder can be configured to obtain, from the broadcast service field, information identifying each of a plurality of different content channels transmitted in the macro-diversity region. The data frame can be an orthogonal frequency division multiple access (OFDMA) frame.

### BRIEF DESCRIPTION OF THE DRAWING(S)

These and other aspects, advantages and details of the present disclosure, both as to its structure and operation, may be gleaned in part by a study of the accompanying exemplary drawings, in which like reference numerals refer to like parts. The drawings are not necessarily to scale, emphasis instead being placed upon illustrating the principles of the disclosure.

FIG. 1 is a block diagram of an example network in which a data frame comprising a macro-diversity region may be used for broadcasting data to a plurality of client stations in accordance with an embodiment.

FIG. 2 is a diagram illustrating an example data frame structure that may be used to transmit data between a base station and a client station in accordance with an embodiment.

FIG. 3 illustrates an example of the operation or function of a macro-diversity region control module in accordance with an embodiment.

FIG. 4 is an illustration of an application layer protocol that runs at the macro-diversity region control module and the Access Service Network-Gateway (ASN-GW) in accordance with an embodiment.

FIG. 5 illustrates an example of an MRDP_MBSC state transition diagram in accordance with an embodiment.

FIG. 6 illustrates an example of MRDP_ASN state transition diagram in accordance with an embodiment.

FIG. 7 is an alternative example of a macro-diversity region control module in accordance with an embodiment.

FIG. 8 is a block diagram illustrating a simplified exemplary embodiment of a base station.

FIG. 9 is an illustration of base station synchronization using a time reference and a frame offset in accordance with an embodiment.

FIG. 10 is one example illustration of the relationship of a time reference, frame offset information and system clock in accordance with an embodiment.

FIG. 11 is an example of a method of synchronizing a macro-diversity region transmitted by a base station in a network in accordance with an embodiment.

FIG. 12 is an example of a method of synchronizing a macro-diversity region transmitted by a base station in a network in accordance with an embodiment.

FIG. 13 is a diagram illustrating a layering model that performs processes in accordance with various protocol modules in accordance with an embodiment.

FIG. 14 is a diagram illustrating an exemplary broadcast service tag announcement in accordance with an embodiment.

FIG. 15 is a flow chart of an exemplary method for building broadcast service announcement TLVs to be included in an SII-ADV message in accordance with an embodiment.

FIG. 16 is a simplified block diagram illustrating an exemplary macro-diversity region control module in accordance with an embodiment.

FIG. 17 is a simplified block diagram illustrating an example embodiment of portions of a client station in accordance with an embodiment.

### DETAILED DESCRIPTION OF THE PREFERRED EMBODIMENT(S)

Certain embodiments as disclosed herein provide for methods and systems for synchronization of base transceiver stations (BTS), or base stations, in a network, for example, a network, such as a single frequency network (SFN). Certain embodiments as disclosed herein provide for methods and systems for communication over a broadband wireless air interface. After reading this description it will become apparent how to implement the various alternative embodiments and alternative applications. However, although various embodiments will be described herein, it is understood that these embodiments are presented by way of example only, and not limitation. As such, this detailed description of various alternative embodiments should not be construed to limit the scope or breadth of the present disclosure.

Methods, apparatuses and techniques are described for synchronizing transmissions for a plurality of base stations in a single frequency network. In embodiments described herein, techniques are described for synchronization of a macro-diversity region, such as a Multi-cast Broadcast Service (MBS) region, used to transmit data within a frame structure that is common to all base stations belonging to a particular SFN network. In other words, the macro-diversity regions in the transmissions from all of the base stations in a SFN are synchronized. As described further below, examples are provided of the types of information that may be expected to be sent to the base stations by other network entities as well as the actions that the base stations may take upon reception of the information.

In accordance with an embodiment, a plurality of base station transceivers (BTSs) broadcast content data to a plurality of client stations in a network. This network may be, for example, a single frequency network (SFN). As used herein, a SFN refers to a network capable of simultaneously broadcasting the same signal (i.e., the same content) over the same frequency channel from multiple transmitters (e.g., BTSs). Further, as used herein the term “content data” refers to any data regarding any information that may be of interest to a user, such as, for example, audio (e.g., music, speech, etc.), visual (e.g., pictures, images, movies, television, etc.), textual (e.g., word processing documents, spreadsheets, etc.), or other types of data regarding content of possible interest to a user. Further, as used herein the term “broadcast service” refers to a collection of broadcasted content data. For example, in an embodiment, a client station may subscribe to a particular broadcast service that includes one or more channels of audio/video content data, such as, for example, a plurality of news channels (e.g., CNN, Fox News, etc.), a plurality of television channels for a particular locality (e.g., WABC, WNBC, etc.), a plurality sports channels (e.g., ESPN), etc. This collection of channels may be provided by, for example, an application service provider (ASP) or other content provider and the content data for each channel encoded using a common type of encoding (e.g., MPEG) and resolution (e.g., low resolution for cell phone displays, high resolution for high definition televisions, etc.)

In an embodiment, the BTSs are configured to broadcast content data to the client stations using a macro-diversity, or broadcast, region of a downlink frame in a communication signal transmitted by the BTSs. As used herein, the term “macro-diversity region” refers to a portion of a data frame useable for broadcasting information. Exemplary macro-diversity regions include, for example, a Multicast and Broadcast Services (MBS) region of an Orthogonal Frequency Division Multiple Access (OFDMA) data frame, such as, for example, an OFDMA data frame in accordance with the Worldwide Interoperability for Microwave Access (WiMAX) standards (i.e., the Institute for Electrical and Electronics Engineers (IEEE) 802.16 Working Group on Broadband Wireless Access Standards). A further description of an exemplary macro-diversity region of a data frame is presented below. Further, as used herein the terms macro-diversity region and broadcast region are interchangeable.

In accordance with an embodiment, each BTS broadcasting content data broadcasts a management message, such as, for example, a medium access control (MAC) message, that includes information identifying the broadcasted content data. This management message may, for example, include the broadcast channel identifier (CID) to identify that the particular BTS broadcasts the particular content data identified by the broadcast CID. For example, a BTS may broadcast a MAC management message including a broadcast CID that identifies that a particular broadcast service (i.e., the content data associated with the particular broadcast service) is included in a macro-diversity region broadcasted by the BTS. In an embodiment, this MAC management message is broadcast in a region of the data frame typically used for transmitting other types of MAC messages as opposed to the macro-diversity region of the data frame. Further, in an embodiment, this MAC message may comprise additional information, such as, for example, information identifying the type of encoding used in encoding the content data, the resolution of the content data, and identifiers for the particular channels of content data (e.g., ESPN, CNN, etc.) broadcasted in the macro-diversity region. A further description of an exemplary MAC message is provide below as well as exemplary locations in a data frame for transmitting the MAC message along with the information this exemplary message may contain. Further, in yet another embodiment, this management message identifying the broadcasted data in the data frame may be provided using other mechanisms, such as, for example, providing the manage message using a separate overhead channel using, for example, a different frequency channel than used for transmitting the data frame.

This MAC message may then be received by the client stations and examined to determine if the BTS is broadcasting content data of interest to the client station. If not, the client station can ignore the signal broadcast by the BTS. If, however, the MAC message identifies that the BTS is broadcasting content data desired by the client station, the client station may then decode the macro-diversity region of the data frame and retrieve the content data of interest.

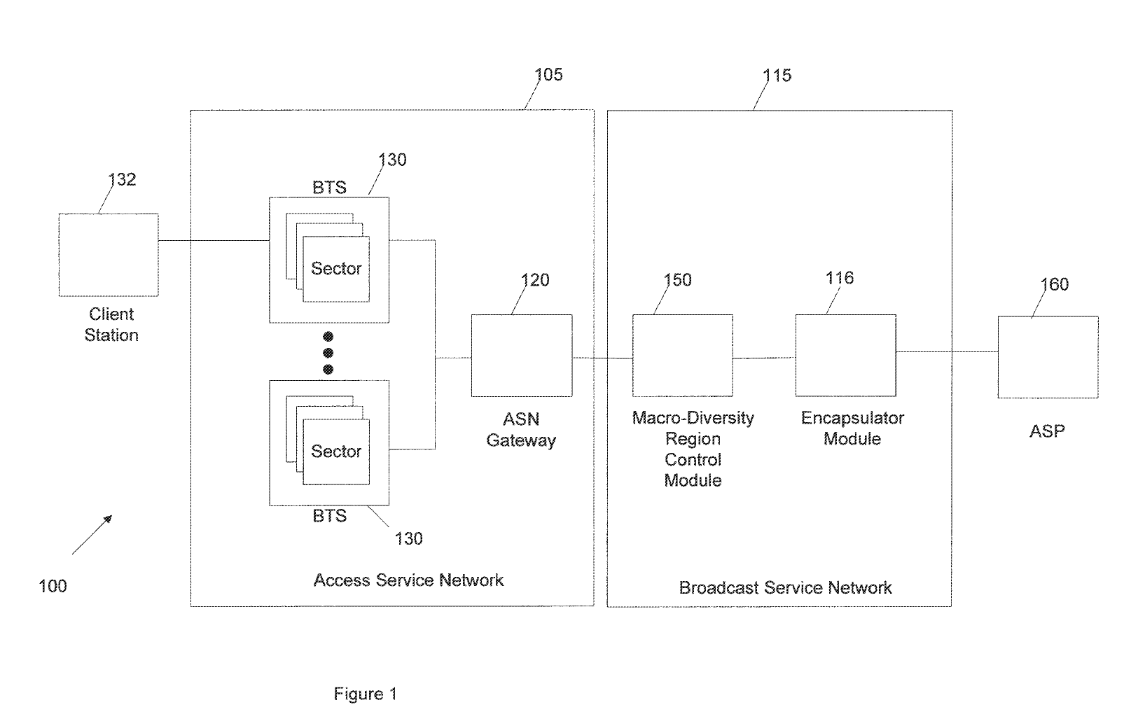

FIG. 1 is a block diagram of an example network 100 for broadcasting data to a plurality of client stations 132 in accordance with an embodiment. For exemplary purposes, network 100 will be described with reference to a network 100 in which data is broadcast to client stations 132 using a macro-diversity region of a data frame, such as, for example, an macro-diversity region of a Worldwide Interoperability for Microwave Access Orthogonal Frequency-Division Multiple Access (WiMAX OFDMA) frame. Other exemplary embodiments utilize other frame based systems including, for example Long Term Evolution (LTE) system or other now or later developed communications systems. LTE is the name given to a project within the Third Generation Partnership Project to improve the Universal Mobile Telecommunications System (UMTS) mobile phone standard to cope with future requirements.

In the example illustrated in FIG. 1, the network 100 includes at least one client station 132, an Access Service Network (ASN) 105, a Broadcast Services Network (BSN) 115, and an Application Service Provider (ASP) 160. In the present example, ASP 160 provides one or more streams of internet protocol (IP) packets comprising content data for broadcast to the client stations 132. Broadcast services network 115, as illustrated, receives the stream(s) of IP packets and processes and packages the received content data for broadcast to client stations 132. ASN 105 may provide access services between the broadcast services network 115 and client stations 132 in transmitting the content data to the client stations 132.

As noted above, ASP 160 provides one or more IP streams comprising content data for broadcast to the client stations 132. These IP streams may be provided to the broadcast services network 115 directly or, for example, via a network (not shown), such as a local area network (LAN) (e.g., an Ethernet network), a metro area network (MAN), or a wide area network (WAN) (e.g., the Internet), or a combination thereof.

This content data may comprise, for example, audio (e.g., music, speech, etc.), visual (e.g., pictures, images, movies, television, etc.), textual (e.g., word processing documents, spreadsheets, etc.), or other types of data regarding content of interest to a user. For explanatory purposes, the provided content data will be described as being audio/visual data. Further, in an embodiment, each provided IP stream may comprise content data for a particular audio/visual channel, such as, for example, one or more IP streams may comprise content data for providing a television news program (e.g., CNN, Fox News, etc.), one or more IP streams may be provided for broadcasting movies, one or more IP streams may be provided for transmitting sports programs, etc.

In an embodiment, a broadcast service provided by a particular ASP 160 is identified by a single broadcast channel identifier (CID). As used herein, a broadcast service refers to a collection of content data that may be encoded using a common encoding scheme, such as, for example, (Moving Picture Experts Group) MPEG at a particular resolution (e.g., low resolution for small screens such as mobile phones, high resolution for high definition television (HDTV), etc.). This broadcast CID may then be used by the client stations 132 to determine if the broadcasted content data comprises content data that the client station desires to receive (e.g., the broadcasted content data is for a broadcast service to which the client station subscribes). For example, in an embodiment, there may be multiple ASPs 160 each providing a different broadcast service, where a client station 132 may only be enabled to receive and provide content data belonging to a particular broadcast service (e.g., the client station may only subscribe to the broadcast service proved by one particular ASP).

As illustrated, broadcast service network 115 may include an encapsulator module 116 and a macro-diversity region control module 150. In one embodiment the macro-diversity region control module 150 may be part of, for example, the ASN Gateway 120, or a Network Manager, or other entity. The choice of the entity on which this functionality resides may vary depending on, for example the infrastructure vendor. In addition, the functionality may be distributed across multiple entities. Essentially, the Broadcast Service Network (BSN) and Access Service Network (ASN) blocks are for explanatory purposes, and in some embodiments, the MBS controller or macro-diversity region control module 150 and encapsulator may exist elsewhere and the BSN may be optional. In some embodiments, the macro-diversity region control module 150 and encapsulator may be in the ASN, or in the ASP. Broadcast service network 115 may be operated by a single network service provider (NSP). Further, although for simplification only a single broadcast service network is illustrated, it should be understood that in application there may be multiple broadcast service networks 115 each operated by a different NSP. These other broadcast services networks may be connected to different ASNs 105 and ASPs 160, or for example, multiple broadcast service networks may be connected to a particular ASN and/or ASP.

Encapsulator module 116 may receive the IP streams from ASP 160 and time slice the received IP packets. Encapsulator module 116 may then package the time sliced IP packets into transport packets for wireless transmission of the content data. As used herein, a transport packet refers to any type of data packet useable for transporting data, and may use any type of format or protocol in transporting the data. For example, in an embodiment in which the content data comprises audio/visual content, the encapsulator module 116 may time slice the received IP packets and package the time sliced IP packets in transport packets, such as, for example, Motion Picture Expert Group 2 (MPEG-2) transport packets. Further, in an embodiment, the encapsulator module 116 may perform time slicing operation in accordance with the European Telecommunications Standards Institute (ETSI) standard for Digital Video Broadcast-Handheld (DVB-H) along with performing multi-protocol encapsulation with forward error correction (MPE-FEC). Additionally, in an embodiment, the encapsulator module 116 may wrap the packets (e.g., transport packets) with an IP header prior to outputting the wrapped packets.

The encapsulator module 116 may then provide the transport packets to the macro-diversity region control module 150. The macro-diversity region control module 150 may then package the transport frames for broadcast to the client station 132. Additionally, in an embodiment, the macro-diversity control module 150 may further insert time stamping information in the received transport packets. The time stamping information added to the transport packets (e.g., MPEG-2 transport packets) may be used by the base stations to enable the individual base stations 130 to time synchronize the transmission of the content data to the client stations 132, so that each base station 130 simultaneously transmits the content data. In some embodiments macro-diversity region control module 150 may include a modulation and coding scheme selection information and zone switch parameters in the received transport packets for use by the base stations 130 in transmitting the macro-diversity region. The zone switch parameters refer to parameters for determining the location and characteristics of the macro-diversity region in a frame, for example, the base station transmission frame. An example of a zone switch parameter includes a symbol offset to indicate an offset from the start of the base station transmission frame to identify a location for the macro-diversity region data in the base station transmission frame. The macro-diversity region control module may use a configuration file (described below) to determine the zone switch parameters. In some embodiments the modulation and coding scheme selection information and the zone switch parameters may be configured to ensure that the macro-diversity region is broadcast by the base stations using a common waveform. Further, in an embodiment, the macro-diversity region control module 150 may further combine multiple received transport packets into a larger frame (referred to herein as a “mega-frame”) for transmission by the base stations 130.

In an embodiment, the macro-diversity region control module 150 defines a macro-diversity region for inclusion in a data frame for transmitting the content data to the client stations 132. For example, the macro-diversity region defined may be a Multicast Broadcast Services (MBS) region of an OFDMA data frame, such as, for example, an OFDMA data frame in accordance with Institute of Electrical and Electronics Engineers (IEEE) 802.16e. A further description of the macro-diversity region is provided below.

As illustrated, ASN 105 includes a plurality of base stations 130 and an ASN Gateway 120. In one embodiment, base stations 130 may include an antenna system that is sectorized into one or more sectors with each sector transmitting and receiving signals within a corresponding coverage area, wherein the coverage area of the sector may be the same or less than the total coverage area of the base station. ASN Gateway 120 may provide access gateway functions between the base stations 130 and the broadcast service network 115, and may be, for example, a commercially available ASN Gateway, such as, for example, a Cisco ASN Gateway. It should be further noted that although an ASN Gateway is used in the exemplary embodiment of FIG. 1, in other embodiments an ASN Gateway need not be used.

The defined macro-diversity region may then be communicated to the base stations 130. The base stations 130 may comprise hardware (e.g., a processor, memory, one or more buses, etc.) and software for building data frames including the defined macro-diversity region using the information received from the macro-diversity region control module 150. These data frames may be, for example, OFDMA data frames in accordance with IEEE 802.16e. The base stations 130 may then broadcast the OFDMA data frames including the macro-diversity region. Further, the base stations 130 may be synchronized so that the macro-diversity regions transmitted by the base stations 130 are identical and synchronized. It should be noted that although in this embodiment each base station 130 simultaneously broadcasts a common macro-diversity region, the remainder of the data frames transmitted by each base station 130 need not include common data. A further description of an exemplary data frame comprising a macro-diversity region is presented below.

Client stations 132 may be mobile, nomadic or stationary units. The client stations 132 are often referred to as, for example, mobile stations, mobile units, subscriber stations, wireless terminals or the like. Client station 132 may be, for example, a wireless handheld device, a vehicle mounted device, a portable device, client premise equipment, fixed location device, wireless plug-in accessory or the like. In some cases, client stations 132 may take the form of a handheld computer, a notebook computer, a wireless telephone, personal digital assistant, wireless email device, personal media player or the like. Further, client stations 132 may include a receiver that receives signals broadcasted by ASN 105. Client station 132 may also include one or more displays (e.g., a liquid crystal display (LCD), etc.) and speaker(s) for use in presenting content (e.g., audio and/or visual) to a user of the client device. Optionally, the client station 132 may also include a storage device (e.g., volatile or non-volatile memory) for recording the received data.

It should be noted that although FIG. 1 illustrates exemplary modules for processing the incoming content data for transmitting the content data to the client stations 132 using a macro-diversity region, in other embodiments alternate modules may be used or, for example, the functions performed by the modules may be combined or split into different modules. For example, although FIG. 1 illustrates a macro-diversity control module 150 for time stamping the incoming data and defining a macro-diversity region, in other embodiments, these functions may be split into separate modules. For example, in an embodiment, a single frequency network (SFN) module may be used to time stamp the incoming content data and package the transport packets into mega-frames that it then communicates to the macro-diversity control module over a network, such as an Ethernet network. The macro-diversity control module in such an example, may then define the macro-diversity region using the time stamped information received from the SFN module.

It should also be further noted that although for simplification the presently described embodiment is described with reference to a system in which the BTSs 130 broadcast content data identified by only a single broadcast CID, in other embodiments the BTSs 130 may broadcast content belonging to multiple broadcast CIDs. For example, in an embodiment, one broadcast CID may be used to identify the audio/visual content data from a particular ASP encoded using one encoding scheme (e.g., MPEG data with a low resolution for display on small screens, such as cell phones); a different broadcast CID used to identify audio visual encoded using a different encoding scheme (e.g., MPEG data with a high resolution for display on a high definition television (HDTV), yet a different broadcast CID for identifying audio-only data (e.g., radio programming), etc.

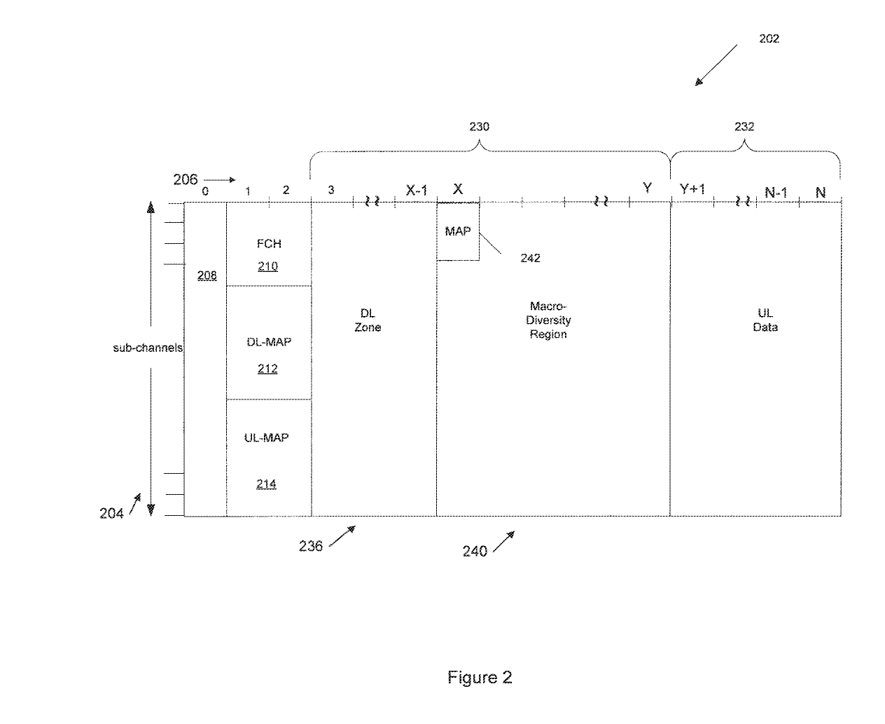

FIG. 2 is a diagram illustrating an example data frame structure that may be used to transmit data between a base station 130 and a client station 132. As noted above, in an embodiment, this data frame may be built by the base stations 130. As illustrated, the data frame 202 structure may be divided into multiple sub-channels 204 (along the vertical axis in FIG. 2), with each sub-channel using a carrier frequency that is orthogonal to the carrier frequencies of other sub-channels. The frame 202 is also divided in time into symbol periods 206 (along the horizontal axis in FIG. 2). As illustrated in FIG. 2, in data frame 202, data may be carried on each of the sub-channel carrier frequencies 204 simultaneously during individual symbol periods 206. Further, a group of consecutive symbols may be treated as a symbol groups, such that the frame 202 is split into a fixed number of symbol groups each consisting of a particular number (e.g., 2, 4, etc.) of consecutive symbols.

In the example of FIG. 2, the data frame 202 includes a preamble 208 during symbol period 0. During symbol periods 1 and 2, the data frame 202 includes a frame control header (FCH) 210 and a downlink media access protocol (DL-MAP) message 212 and uplink media access protocol (UL-MAP) message 214. Generally, the FCH 210 may include information about the frame 202 configuration and about the DL-MAP 212, such as modulation and coding scheme for the DL-MAP 212, DL-MAP 212 message lengths, usable sub-channels of the frame 202, and the like. The DL-MAP 212 can also carry overhead messages that include information broadcast from a base station 130 to at least one client station 132. Alternatively, overhead messages can be included in other portions of the data frame 202.

The downlink and uplink maps 212 and 214 include information about the location of downlink and uplink content within the data frame 202 or a subsequent frame. The data frame 202 includes a downlink region 230 and an uplink region 232 defined by the downlink and uplink maps. Included in the downlink region 230 is a downlink data region 236 and a macro-diversity region 240. While FIG. 2 illustrates an example of the macro-diversity region 240 being located at the end of the downlink region 230, in other embodiments the macro-diversity region 240 can be located at other positions in the downlink region 230. In addition, the macro-diversity region 240 does not need to be continuous, but can be separated into multiple regions within the downlink region 230.

The downlink region 230 may be used for transmitting information from the base stations to the client stations, while the uplink region 232 may be used for transmitting information in the opposite direction, i.e., from the client stations to the base stations. Further, as illustrated, management messages 238 may be transmitted from the base stations to the client stations in the downlink data region 236 of the downlink region 240. These management messages may be, for example, Media Access Control (MAC) management messages. Further, in an embodiment, MAC management messages broadcasted to the client stations may be included in the initial (i.e., far left) portion of the downlink data region 236 with traffic bearing data (e.g., Voice over IP traffic (VOIP), World Wide Web (WWW) data, etc.) and other types of data (e.g., uni-cast MAC management messages) following the broadcasted MAC management messages in the downlink data region 336. Similarly, MAC management messages transmitted from the client stations to the base stations may use the uplink region 232 of the data frame 202. As will be discussed in further detail below, in an embodiment, a MAC management message identifying the content data broadcasted in the macro-diversity region may be broadcast to the client stations using the downlink data region 236 and broadcasted in the same or similar manner that other MAC management messages are broadcast to the client stations.

As noted above, the macro-diversity region 240 of the downlink region 230 may be used by the BTSs for broadcasting content data to the client stations where content data belonging to a particular broadcast service is identified by a broadcast CID. For simplification, in the presently described embodiment, the broadcasted content data will all belong to a single broadcast service identified by a single broadcast CID, however, in other embodiments the macro-diversity region 240 may carry multiple broadcast services each identified by a unique broadcast CID. Further, as noted above, each particular broadcast service may comprise multiple different streams of content data, such as, for example, one or more streams for transmitting news programming (e.g., CNN, Fox News, etc.), one or more streams for transmitting sports programming (e.g., ESPN), etc.

As illustrated, the macro-diversity region 240 may include a macro-diversity region map 242 that defines the size and content of the macro-diversity region 240. In one embodiment, the macro-diversity map 242 rather than defining the macro-diversity region 240 for the data frame 202 the map 242 resides in, the macro-diversity region map 242 defines the size and content of a macro-diversity region 240 in a subsequent data frame 202. For example, the macro-diversity map 242 may define the size and content of a macro-diversity region in the next data frame in time (i.e., the frame sent immediately after the data frame in which the map 242 resides), or the second data frame 202 following the current frame, or other subsequent data frames of data. The map 242 may further include an information element (IE) including a broadcast CID that identifies the broadcast service(s) included in the macro-diversity region 240, or multiple broadcast CIDs in embodiments in which the macro-diversity region 240 includes content data belonging to different broadcast services.

In an embodiment, the base stations 130 may transmit the different regions of frame 202 using different modulation schemes. For example, in an embodiment, the base stations may use a simple modulation for transmitting the preamble 208 (e.g., BPSK), a different modulation scheme for transmitting the downlink data region (e.g., QPSK), yet another modulation scheme for transmitting the macro-diversity region 240 (e.g., QAM), and yet another modulation scheme for transmitting the uplink region 232 (e.g., QPSK).

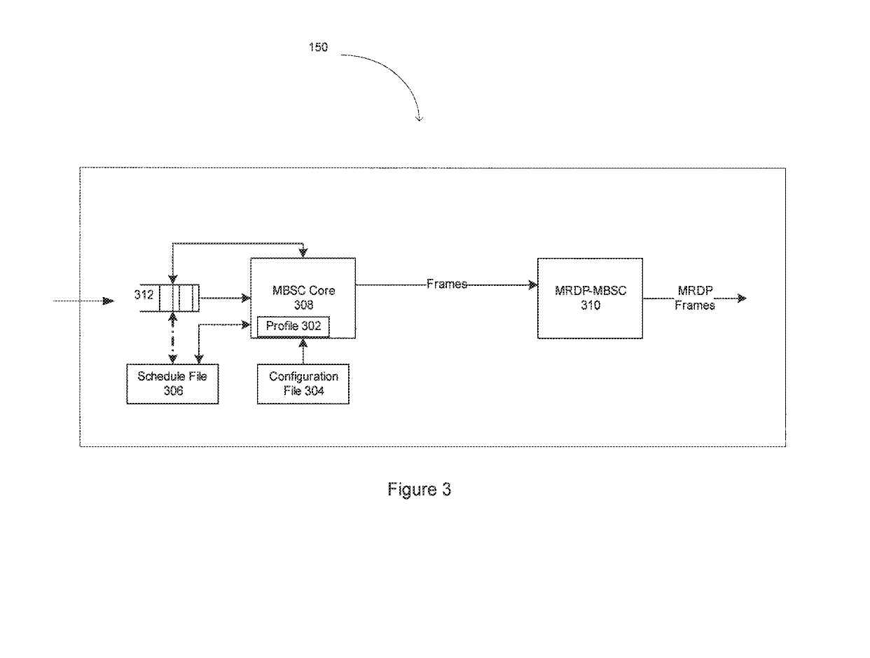

FIG. 3 illustrates an example of the operation or function of a macro-diversity region control module 150 illustrated in FIG. 1 in accordance with an embodiment. For explanatory purposes, FIG. 3 will be discussed with reference to the above-discussed FIG. 1. Note that in FIG. 1 the broadcast data flows from right to left while in FIG. 3 the broadcast data flows from left to right.

As noted above in describing FIG. 1, in an embodiment, the macro-diversity region control module 150 may be, for example, a Multicast Broadcast Service Controller (MBSC). As illustrated, the macro-diversity region control module 150 may have a buffer 312 that may be part of the macro-diversity region control module 150 or may be external but coupled to the macro-diversity region control module 150. The macro-diversity region control module may also have a macro-diversity region control module core 308 or MBSC core coupled to the buffer 312. The macro-diversity region control module 150 behavior can be controlled by three data sets. Each one of these data sets may be stored in an Extensible Markup Language (XML) file, stored by for example a storage (E.g. volatile or nonvolatile RAM, ROM etc.) in the macro-diversity region control module 150. These three files are collectively referenced as setup files and include a Profile File 302, a Configuration File 304 and a Schedule File 306. The Profile File 302, Configuration File 304 and a Schedule File 306 may be generated manually by an administrator, for example an engineer, or by a program outside the macro-diversity region control module 150, and uploaded to the macro-diversity region control module 150. The macro-diversity region control module 150 can also include a macro-diversity region control module core 308 and an MBS Region Distribution Protocol (MRDP)-MBSC interface 310. The Profile File 302 includes a profile that sets the most basic and long term parameters of the macro-diversity region control module 150. A profile change may be, for example, a major change and in some embodiments requires a system reset. For example, in a system employing WiMax in accordance with 802.16, exemplary parameters stored by the profile may include the following:
The output burst type (e.g. hybrid automated repeat request (HARQ) or convolution codes (CC)/convolution turbo codes (CTC)) to be used in transmitting the macro-diversity region;
The number of subchannels allocated to the macro-diversity region;
The permutation type to be used by the base stations in transmitting on the downlink, where the permutation type is a scheme for mapping sub-channels to physical sub-carriers in an OFDMA symbol. (E.g. full usage of sub-carriers (FUSC—this scheme makes up sub-channels by using total sub-carriers assigned for data in total frequency bands), partial usage of sub-carriers (PUSC—this scheme makes up sub-channels by using a portion of sub-carriers assigned for data in total frequency bands), adaptive modulation and coding (AMC—this scheme makes up sub-channels by dividing adjacent bands in total frequency bands));
The modulation type, for example quadrature phase-shift keying (QPSK), quadrature amplitude modulation (QAM) or 64QAM, to be used in transmitting the macro-diversity region;
A backlog target delay (E.g. specified in terms of milliseconds), for example: this parameter states the target average amount of time each data byte stays in the buffer 312 before being allocated to the macro-diversity region;
One or more macro-diversity frame descriptors for defining the structure of the macro-diversity region (Note that in an alternative embodiment, one or more frame region descriptors may be included in a frame lookup table included in the macro-diversity profile);
The number of frame descriptors specified in the lookup table:
The maximum macro-diversity width can be described in this profile;
MBS information element (IE) which specifies constant bit fields of the macro-diversity region;
Cyclic redundancy check-32 (CRC-32): if this option is set, the last four bytes of each PDU will be CRC-32. (CRC is a common technique for detecting data transmission errors).

In one embodiment an active profile can be specified via a Management Information Base (MIB) entry maintained by the macro-diversity region control module 150, where the term active profile refers to the system profile that is currently in use.

The Configuration File 304 may include a number of configuration settings with each configuration setting having one or more parameters governing the behavior of the macro-diversity region control module 150 at a given data rate or at a range of subset of data rates. Generally, the Configuration File may change when, for example, the expected incoming data rates or number of channels over the air changes, with the new Configuration File having different values for the parameters. In an exemplary system employing WiMax in accordance with 802.16 exemplary configuration parameters may include:
Incoming data rate in bits per second;
Space maximum macro-diversity region width at the specified incoming data rate in terms of the number of symbol groups;
The number of symbols in the DL sub-frame to be used by the base stations in transmitting to the client stations;
An MBS_IE overwrite pattern that can be encoded in Base-64; for example, an MBS_IE overwrite pattern may be included that specifies the location of bits in an MBS_IE stored by the Profile File 302 that can be overwritten;
An MBS_MAP overwrite pattern encoded in base-64 that specifies the location of bits in an MBS_MAP stored by Profile File 302 that may be overwritten;
One or more backlog tolerance margins that specify the percentage of high and low levels of content data in the buffer 312, for example, for a target backlog buffer level of 100 bytes the backlog tolerance margins may be between 100.40 and 99.70 bytes;
The feedback loop delay specifies the minimum number of OFDMA frames between two consecutive measurements of the backlog level after any width change of the macro-diversity region frame;
A downstream target delay that specifies the amount of time between generation of a frame and its over the air broadcast; this target delay may be used in time stamping of generated frames that will be discussed further in detail below; Further this target delay, in some embodiments, may be selected large enough to take into account for distribution of the frame to all base stations in the network;
An interface protocol type for use in communications between the macro-diversity region control module 150 and the ASN-GW 120;
A minimum starting symbol such that the macro-diversity region may not occupy a symbol period smaller than this parameter;
A maximum finishing symbol such that the macro-diversity region may not occupy a symbol period after this parameter and frame descriptor.

In some embodiments, the configuration setting may adjust the set of system parameters that are dependent on the incoming rate and are susceptible to change as a result of the change in the incoming rate. The set of system parameters may be a group of dependent parameters that usually need to change together. Some of these system parameters are loosely dependent on the information in the profile 302, but they may also identify shorter term rate dependent behavior of the system. In one embodiment, the Configuration File 304 may be generated manually by an administrator, for example an engineer, or by a program outside the macro-diversity region control module 150. The Configuration File may be generated with knowledge of the active profile in use and may be consistent with the active profile, where the term active profile refers to the system profile that is currently in use. The configuration file may be uploaded and stored in the macro-diversity region control module 150.

The Schedule File 306 includes a plurality of schedule entries defining a schedule of rate changes. The set of parameters associated with the Schedule File 306 may specify what input rates may be expected at any given time. In one embodiment Schedule File 306 may be loaded to the MBSC management information base (MIB) such that it can be updated via a Simplified Network Management Protocol (SNMP) connection. The MIB refers to a database of system parameters which can be queried and changed (with some access provisions) remotely via the SNMP protocol. Each schedule entry includes a specified instance of time and a specified input rate to indicate the specified instance of time the next rate change schedule becomes effective. The macro-diversity region control module 150 chooses the configuration setting that provides the best match for the data rate specified by the Schedule File 306 for the current instance of time. Profile Files 302 and Configuration Files 304 are usually static elements of the system. For example, although it is expected that the Configuration File 304 will be normally static, it may be changed in certain circumstances such as noted above.

The macro-diversity region control module may provide the capability of changing the active Configuration File. A MIB element may specify the new Configuration File along with the time of the change of the Configuration File. The new Configuration File may become effective at the scheduled rate change that coincides with the time specified in the MIB entry. The fundamental behavior of the macro-diversity region control module may be regulated by a set of parameters specified by the active profile. The macro-diversity region control module core 308 may extract the frame structure, for example frame length, from the Profile File 302, populate the frame and send the populated frame to an interface 310 that may use a proprietary interface, where the populated frame may subsequently be transmitted to the ASN-GW 120, for example. For exemplary purposes, an interface that may be used will be referred to herein as MRDP-MBSC. The MRDP-MBSC 310 may be an application layer protocol that runs at the macro-diversity region control module 150, and serves as the interface to external devices, for example, the ASN-GW 120 illustrated in FIG. 1.

In one embodiment, the macro-diversity region control module 150 may adopt a configuration setting from the Configuration File 304 based on the Schedule File 306. The configuration setting specifies the incoming data rate from the IP encapsulator 116 illustrated in FIG. 1. The incoming data stream may be deposited into the buffer 312, where the macro-diversity region control module core 308 can monitor the backlog level of the buffer 312 and keep the backlog level within a target range. The macro-diversity region control module core 308 can keep the backlog within a target range by controlling the outgoing data rate by changing the width of the macro-diversity region. This process of balancing the incoming data rate with the outgoing data rate can be decided by a buffer balancing algorithm and is referred to herein as rate matching. The structure of the macro-diversity region as well as the structure of these OFDMA frames may be described in the profile according to the Configuration File 304 and the Profile File 302. The frame description may define the structure of the macro-diversity region including the structure of the frame and how it actually will be filled with data bytes. The macro-diversity region control module fills up each frame with data bytes from the buffer 312 in accordance with the specified frame structure.

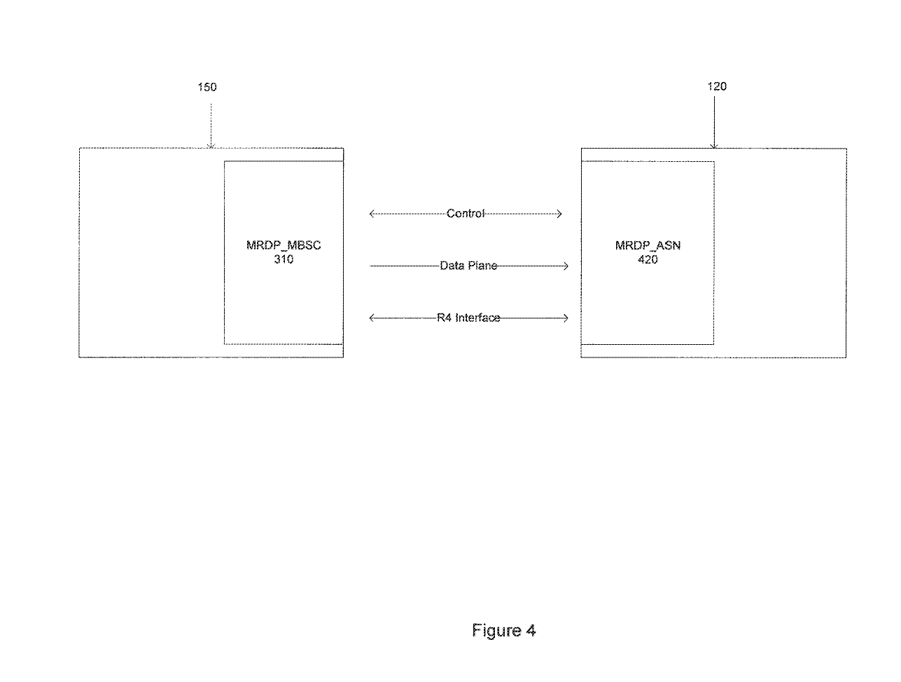

FIG. 4 is a simplified diagram illustrating an application layer protocol that runs at the macro-diversity region control module 150 and the ASN-GW 120 according to an embodiment. For explanatory purposes, FIG. 4 will be discussed with reference to the above-discussed FIGS. 1 and 3. An application layer protocol, for example a proprietary application layer protocol, runs at the macro-diversity region control module 150 and the ASN-GW 120 using an interface, for example an R4 interface. The R4 interface may include a set of protocols originating/terminating in various entities within the ASN-GW 120 and/or macro-diversity region control module 150, for example, for coordinating data mobility between the ASN-GW 120 and the macro-diversity region control module 150. For explanatory purposes an embodiment of this interface will be hereinafter referred to as MRDP. The MRDP_MBSC functional instance 310 is situated at the macro-diversity region control module 150 and the MRDP_ASN functional instance 420 is situated at the ASN-GW. The MRDP protocol provides a communication link between the macro-diversity region control module 150 and the ASN-GW 120 that the macro-diversity region control module 150 may use to send information regarding the macro-diversity region to the ASN-GW 120 over the R4 interface. In some embodiments two types of information flow between the macro-diversity region control module 150 and the ASN-GW 120. The first is control messages that go in both directions between the MRDP_MBSC 310 and the MRDP_ASN 420. The second is data plane messages (i.e., messages comprising the packets of content data for broadcast to the client stations 132) going from the MRDP_MBSC 310 to the MRDP_ASN 420.

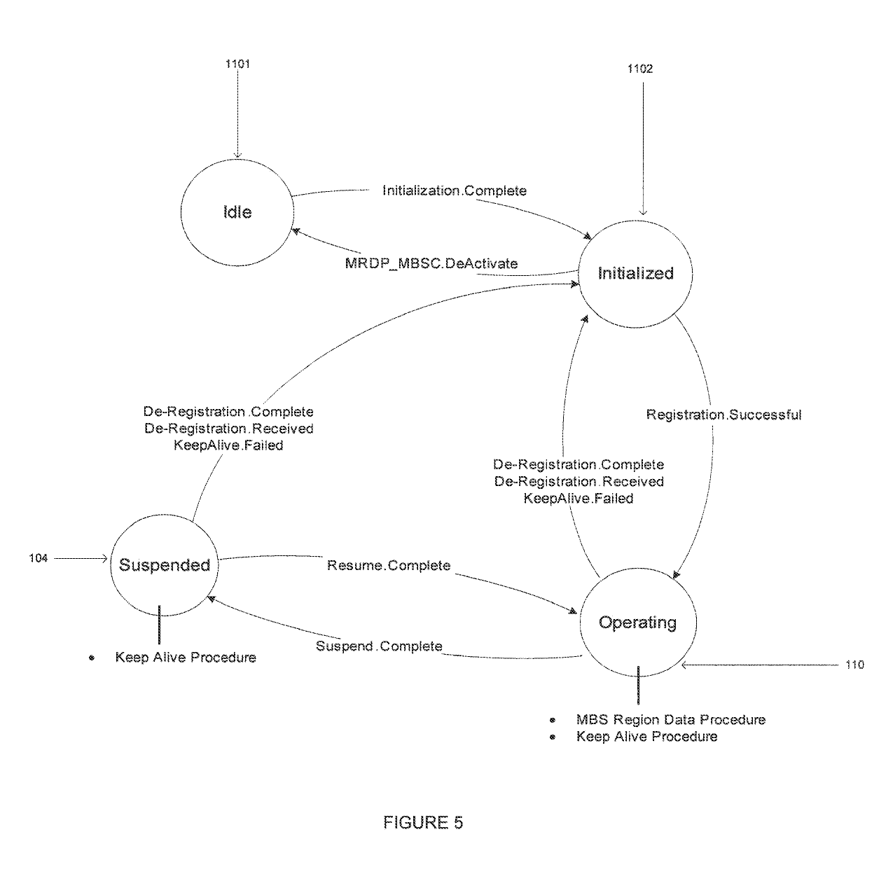

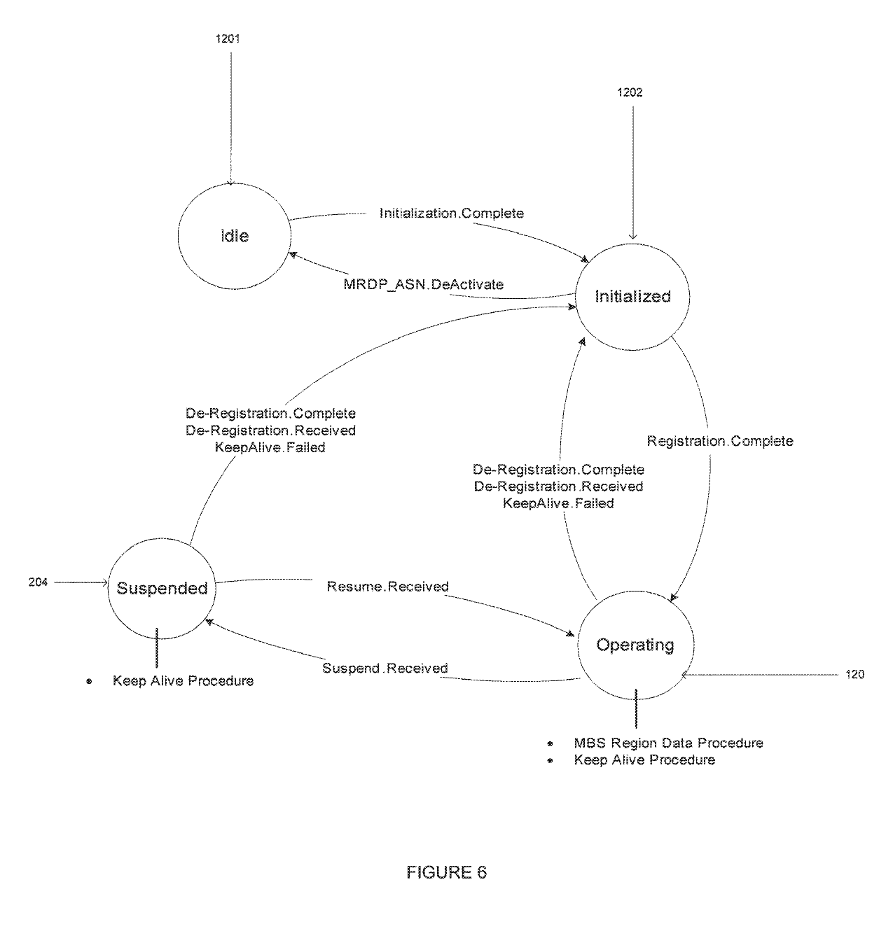

FIG. 5 and FIG. 6 illustrates an example of a state transition diagram of the MRDP_MBSC and MRDP_ASN respectively. Each of the MRDP procedures described below may be initiated by, for example, either the above-discussed MRDP_MBSC 310 or MRDP_ASN 420 to accomplish an action or indicate a condition. The MRDP procedures described are state dependent and therefore may be initiated in certain MRDP states. For any given MRDP procedure described below, the instructions received or sent by a state machine for example MRDP_MBSC or MRDP_ASN may be in the form of commands and indications. The MRDP_MBSC or MRDP_ASN may have four states including Idle State 1101 or 1201 respectively, Initialized State 1102 or 1202 respectively, Operating State 1103 or 1203 respectively and Suspended State 1104 and 1204 respectively.

In one embodiment when the macro-diversity region control module 150 or the ASN_GW 120 have just powered on or have been through a reset cycle, MRDP_MBSC or MRDP_ASN will start off at the Idle State 1101 or 1202. The MRDP_MBSC or MRDP_ASN does nothing in Idle State but wait for a command to be activated. The activation commands may be, for example, MRDP_MBSC.Activate command or MRDP_ASN.Activate command, from the macro-diversity region control module 150 or ASN-GW 120 that starts an initialization procedure. In one embodiment the MRDP_MBSC or MRDP_ASN ignores any other commands or messages in the Idle State 1101 or 1201 other than the initialization commands (E.g. MRDP_MBSC.Initialized or MRDP_ASN.Initialized). The initialization procedure is used by one MRDP endpoint, for example MRDP_MBSC or MRDP_ASN, to initialize and prepare to perform other procedures. In some embodiments both the MRDP_MBSC and the MRDP_ASN may start their own initialization procedure independently and asynchronously. The activation commands from the macro-diversity region control module 150 or ASN-GW 120 may trigger the MRDP_MBSC or MRDP_ASN state machine to issue an initialization procedure command. (E.g. InitializationProc.Activate command). When the initialization process is complete, the MRDP_MBSC or MRDP_ASN receives an initialization process complete command (E.g. InitializationProc.Complete) and the MRDP_MBSC or MRDP_ASN issues an indication that the MRDP_MBSC or MRDP_ASN is initialized (E.g. MRDP_MBSC.Initialized or MRDP_ASN.Initialized) to the MBSC core 308 or ASN-GW core (not shown) function. The MRDP_MBSC then transitions from the Idle State 1101 to the Initialized State 1102 illustrated in FIG. 5 (initialization complete). Likewise the MRDP_ASN transitions from the Idle State 1201 to the Initialized State 1202 illustrated in FIG. 6.

In the Initialized State 1102, the MRDP_MBSC is waiting for a register command (E.g. MRDP_MBSC.Register command) from MBSC core function to initiate a Data Path Registration Procedure that will allow the MRDP_MBSC to transition to the Operating State 1103 to start the macro-diversity region data transmission. Likewise in the Initialized State 1202, the MRDP_ASN is waiting for the registration request message from the macro-diversity region control module 1500 in order to start the Data Path Registration Process.

If the MRDP_MBSC receives the register command from the macro-diversity region control module core 308, the MRDP_MBSC may issue a command to activate the registration procedure (E.g. RegistrationProc.Activate command) in order to start the Data Path Registration Procedure. If the MRDP_MBSC receives an indication that the registration procedure failed (E.g. RegistrationProc.Failed indication) the MRDP_MBSC may issue an indication that the MRDP_MBSC registration failed. (E.g. MRDP_MBSC.RegFailed indication) to MBSC core function. However, if the MRDP_MBSC receives an indication that the registration procedure succeeded (E.g. RegistrationProc.Successful indication) the MRDP_MBSC may issue an indication that the MRDP_MBSC is operating to MBSC core function. (E.g. MRDP_MBSC. Operating indication). The MRDP_MBSC then transitions from the Initialized State 1102 to the Operating State 1103. On the other hand, if the MRDP_MBSC receives a deactivation command (E.g. MRDP_MBSC.DeActivate command) from the MBSC 150, the MRDP_MBSC may issue a registration procedure deactivation command (E.g. RegistrationProc.DeActivate command) and issue an indication that the MRDP_MBSC has transitioned back to its Idle State 1101. In one embodiment the MRDP_MBSC may ignore any other commands or messages in Initialized State 1102 other than the register command.

Similarly, if the MRDP_ASN receives a RegistrationProc.Complete indication that the registration procedure has been completed, the MRDP_ASN may issue an indication that the MRDP_ASN is in operation. (E.g. MRDP_ASN.Operating) to the ASN-GW core function. The MRDP_ASN then transitions from the Initialized State 1202 to the Operating State 1203. However if the MRDP_ASN receives a command to deactivate (E.g. MRDP_ASN.DeActivate command) from the ASN-GW core function, the MRDP_ASN may issue a RegistrationProc.DeActivate command and issue an indication that the MRDP_ASN has transitioned back to its Idle state 1201 to the ASN-GW core function. In one embodiment the MRDP_ASN can ignore any other commands or messages in Initialized State 1202 other than the above-described.

After registration, the MRDP_MBSC enters the Operating State 1103 and starts to send out macro-diversity region data. In the Operating State the MRDP_MBSC may issue various commands including a command to activate the procedure that monitors the network connection between the macro-diversity region control module 150 and the ASN-GW (E.g. KeepAliveProc.Activate command) (hereinafter the keep alive procedure) and a command to activate the macro-diversity region Data transmission (E.g. MBSDataProc.Activate command). The procedure to monitor the network connection between the macro-diversity region control module 150 and the ASN-GW may be active throughout the duration of the Operating State 1103 and the Suspended State 1104. If MRDP_MBSC receives a command from the macro-diversity region control module core 308 function to suspend the Operating State 1103 (E.g. MRDP_MBSC. Suspend command) the MRDP_MBSC may issue a command to activate the suspend procedure. (E.g. SuspendProc.Activate command). If MRDP_MBSC receives an indication from the macro-diversity region control module core 308 that the suspend procedure has been completed (E.g. SuspendProc.Complete indication), the MRDP_MBSC may issue a command to deactivate the macro-diversity region data transmission (E.g. MBSDataProc.DeActivate command) and an indication to suspend the MRDP_MBSC (E.g. MRDP_MBSC.Suspended indication). The MRDP_MBSC then transitions from the Operating State 1103 to the Suspended State 1104 where the macro-diversity region data transmission is suspended. If MRDP_MBSC receives a de-registration command from macro-diversity region control module core 308 function (E.g. MRDP_MBSC.DeRegister command), the MRDP_MBSC may issue a command to activate the de-registration procedure. (E.g. De-RegistrationProc.Activate command). If MRDP_MBSC receives an indication from the macro-diversity region control module core 308 that includes an indication that the de-registration request message has been completed (E.g. De-RegistrationProc. Complete indication), or an indication that a de-registration procedure has been received (E.g. De-RegistrationProc.Received indication) or an indication that the network connection between the macro-diversity region control module 150 and the ASN-GW failed to be kept alive (E.g. KeepAliveProc.Failed indication) the MRDP_MBSC may issue a various commands and indications including a command to deactivate the macro-diversity region data transmission (E.g. MBSDataProc.DeActivate command), a command to deactivate the keep alive procedure (E.g. KeepAliveProc.DeActivate command), a command to de-activate the de-registration procedure or (E.g. De-RegistrationProc.DeActivate command), a command to de-activate the suspend procedure. (E.g. SuspendProc.DeActivate command) and an indication that the MRDP_MBSC is initialized (E.g. MRDP_MBSC.Initialized). The MRDP_MBSC then transitions from the Operating State 1103 to the Initialized State 1102. In one embodiment the MRDP_MBSC can ignore any other commands or messages in Operating State 1103 other than the above-described suspend the Operating State 1103 command or de-registration command.

If MRDP_MBSC receives a command from the macro-diversity region control module core 308 function to resume the Operating State 1103 (E.g. MRDP_MBSC.Resume command) the MRDP_MBSC may issue a command to activate the resume procedure. (E.g. ResumeProc.Activate command). If MRDP_MBSC receives an indication from the macro-diversity region control module core 308 that the resume procedure has been completed (E.g. ResumeProc.Complete command) the MRDP_MBSC may issue an indication that the MRDP_MBSC is operating (E.g. MRDP_MBSC. Operating indication). The MRDP_MBSC then transitions from the Suspended State 1104 to the Operating State 1103. If MRDP_MBSC receives a de-registration command from macro-diversity region control module core 308 (E.g. MRDP_MBSC.DeRegister command), the MRDP_MBSC may issue a command to activate the de-registration procedure. (E.g. De-RegistrationProc.Activate command). If MRDP_MBSC receives an indication from the macro-diversity region control module core 308 that includes an indication that the de-registration procedure has been completed (E.g. De-RegistrationProc. Complete indication), or an indication that a de-registration procedure has been received (E.g. De-RegistrationProc.Received indication) or an indication that the network connection between the macro-diversity region control module 150 and the ASN-GW failed to be kept alive (E.g. KeepAliveProc.Failed indication) the MRDP_MBSC may issue a various commands and indications including a command to deactivate the network connection between the macro-diversity region control module 150 and the ASN-GW (E.g. KeepAliveProc. DeActivate command), a command to de-activate the de-registration procedure (E.g. De-RegistrationProc. DeActivate command), a command to de-activate the resume procedure. (E.g. ResumeProc.DeActivate command) and an indication that the MRDP_MBSC is initialized (E.g. MRDP_MBSC.Initialized). The MRDP_MBSC then transitions from the Suspended State 1104 to the Initialized State 1102. In one embodiment the MRDP_MBSC can ignore any other commands or messages in Suspended State 1104 other than the above described command to resume the Operating State 1103 or a command to activate the de-registration procedure.

Similarly, after registration, the MRDP_ASN enters the Operating state 1203 and starts to receive macro-diversity region data. In the Operating State 1203 the MRDP_ASN may issue various commands including a command to activate the procedure that monitors the network connection between the macro-diversity region control module 150 and the ASN-GW (E.g. KeepAliveProc.Activate command) and a command to activate the macro-diversity region data transmission (E.g. MBSDataProc.Activate command). The procedure that monitors the network connection between the macro-diversity region control module 150 and the ASN-GW may be active throughout the duration of the Operating State 1203 and the Suspended State 1204. If the MRDP_ASN receives a de-registration command from ASN-GW (E.g. MRDP_ASN.DeRegister command), the MRDP_ASN may issue a command to activate the data path de-registration procedure. (E.g. De-RegistrationProc.Activate command). If MRDP_ASN receives an indication from the ASN-GW that includes an indication that the de-registration procedure has been completed (E.g. De-RegistrationProc. Complete indication), or an indication that a de-registration procedure has been received (E.g. De-RegistrationProc.Received indication) or an indication that the network connection between the macro-diversity region control module 150 and the ASN-GW failed to be kept alive (E.g. KeepAliveProc.Failed indication) the MRDP_ASN may issue various commands and indications including a command to deactivate the macro-diversity region data procedure (E.g. MBSDataProc.DeActivate command), a command to deactivate the procedure that monitors the network connection between the macro-diversity region control module 150 and the ASN-GW (E.g. KeepAliveProc. DeActivate command), a command to de-activate the de-registration procedure. (E.g. De-RegistrationProc.DeActivate command) and an indication that the MRDP_ASN is initialized (E.g. MRDP_ASN.Initialized). The MRDP_ASN then transitions from the Operating State 1203 to the Initialized State 1202. In one embodiment the MRDP_ASN can ignore any other commands or messages in Operating State 1203 other than the above described command to activate the macro-diversity region data transmission or a command to activate the data path de-registration procedure.

If MRDP_ASN receives a command from the ASN-GW to suspend the Operation State 1203 (E.g. SuspendProc.Received command) the MRDP_ASN may issue a command to deactivate the macro-diversity region data procedure (E.g. MBSDataProc.DeActivate command) and an indication to suspend the MRDP_ASN (E.g. MRDP_MBSC.Suspended indication). The MRDP_ASN then transitions from the Operating State 1203 to the Suspended State 1204 where the macro-diversity region data transmission is suspended. The Suspend State may be entered because at certain periods of time (e.g. at night) no content data is broadcast so the ASN-GW is instructed no to expect MBS traffic. If MRDP_ASN receives an indication that the macro-diversity region data procedure is in error (E.g. MBSDataProc.Error) the MRDP_ASN may issue an error warning indication (E.g. MRDP_ASN.MBSDataError) to the ASN-GW.

In one embodiment if the MRDP_ASN is in the Suspended state 1204 and receives a resume procedure indication (E.g. ResumeProc.Received indication) the MRDP_ASN may issue an indication that the MRDP_ASN is operating (E.g. MRDP_ASN. Operating indication). The MRDP_ASN then transitions from the Suspended State 1204 to the Operating State 1203. If MRDP_ASN receives an indication that the de-registration procedure has been completed (E.g. De-RegistrationProc. Complete indication), or an indication that a de-registration procedure has been received (E.g. De-RegistrationProc.Received indication) or an indication that the network connection between the macro-diversity region control module 150 and the ASN-GW failed to be kept alive (E.g. KeepAliveProc.Failed indication) the MRDP_ASN may issue a various commands and indications including a command to deactivate the procedure that monitors the network connection between the macro-diversity region control module 150 and the ASN-GW (E.g. KeepAliveProc, DeActivate command), a command to de-activate the de-registration procedure. (E.g. De-RegistrationProc.DeActivate command), a command to de-activate the resume procedure. (E.g. ResumeProc.DeActivate command) and an indication that the MRDP_MBSC is initialized (E.g. MRDP_ASN.Initialized). The MRDP_ASN then transitions from the Suspended State 1204 to the Initialized State 1202. In one embodiment the MRDP_MBSC can ignore any other commands or messages in Suspended State 1204 other than the above described resume procedure message.

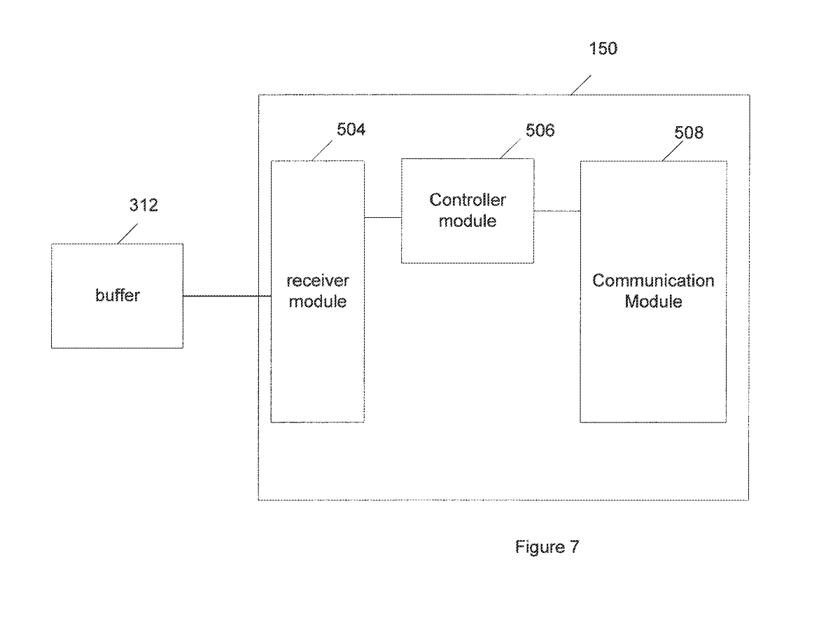

FIG. 7 is an example of a macro-diversity region control module 150 illustrated in FIG. 1 in accordance with an embodiment. For explanatory purposes, FIG. 7 will be discussed with reference to the above-discussed FIG. 1. Also FIG. 7 is an alternative embodiment of the macro-diversity region control module 150 of FIG. 3. Note that FIG. 3 is focused on the data sets that control the behavior of the macro-diversity region control module 150. As illustrated, the macro-diversity region control module 150 may have a buffer 312 described in reference to FIG. 3 above that may be a part of the macro-diversity region control module 150 or external to but coupled to the macro-diversity region control module 150. The macro-diversity region control module 150 may also include a receiving module 504, a controller module 506 and a communication module 508. The receiving module may be coupled to the controller module 506 and configured to receive a plurality of packets of content data from the buffer 312. The plurality of packets of content data may originate from an ASP 160 of FIG. 1.

In one embodiment, the controller module 506 may be configured to generate macro-diversity region data that includes at least one packet of the plurality of packets of content data. The controller module 506 may also generate macro-diversity region control information including time reference and frame offset information. Using a frame offset is advantageous because the base stations may use different numbering schemes for numbering frames. For example an old base station may be up to frame number 1023000 while a new base station may start using frame number 1. The macro-diversity region control information may be configured to enable synchronization of the transmission of the macro-diversity region data by the plurality of base stations. The control information may indicate an offset from the time reference to further indicate a base station transmission frame that will include the macro-diversity region data at a plurality of base stations. In some embodiments the control information may include a modulation and coding scheme selection information to use in transmitting the macro-diversity region at the base stations. In other embodiments the control information may also include zone switch parameters where the zone switch parameters refer to parameters that determine the location and characteristics of the macro-diversity region in a frame, for example, the base station transmission frame. An example of a zone switch parameter includes a symbol offset to indicate an offset from the start of the base station transmission frame to identify a location for the macro-diversity region data in the base station transmission frame. The macro-diversity region control module may use a configuration file (described above) to indicate the zone switch parameters. In some embodiments the control information including the modulation and coding scheme and the zone switch parameters may be configured to ensure that the macro-diversity region is broadcast by each of the base stations using a common waveform.

In one embodiment the time reference may be expressed in coordinated universal time (UTC). The macro-diversity region control module may include a global positioning system (GPS) receiver to receive information, for example information related to time, from a global positioning system. In some embodiments the time related information may be used to generate the time reference. The macro-diversity region control information may include a symbol offset to indicate an offset from the start of the base station transmission frame to identify a location for the macro-diversity region data in the base station transmission frame. The communication module 508 may be coupled to the controller module 506, to communicate a macro-diversity region message that includes the macro-diversity region data and the macro-diversity region control information to a plurality of base stations. In one embodiment the communication module 508 may include the MRDP interface described above in reference to FIG. 4. In one embodiment, the controller module 506 may also be configured to determine the size of the macro-diversity region data, the location of the macro-diversity region, an allocation of content data to be broadcast in the macro-diversity region and to determine a broadcast map detailing the structure of the macro-diversity region data.

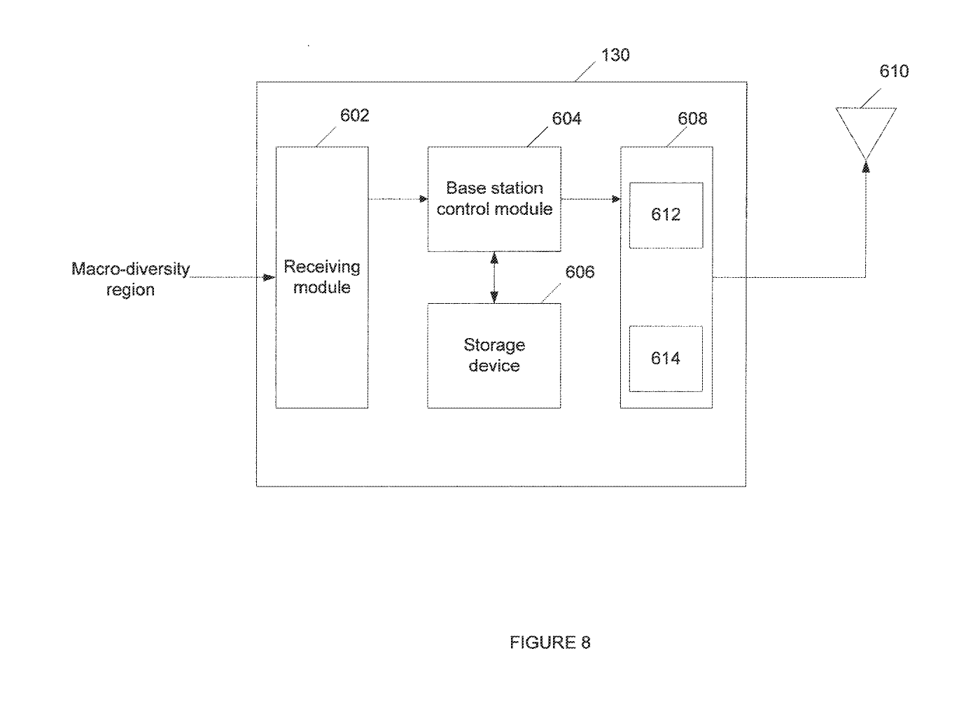

FIG. 8 is a block diagram illustrating a simplified exemplary embodiment of a base station 130 illustrated in FIG. 1 in accordance with an embodiment. For explanatory purposes, FIG. 8 will be discussed with reference to the above-discussed FIG. 1. As illustrated, base station 130 may include an interface module 602, a base station control module 604, a storage device 606, a transceiver 608, and an antenna 610. The transceiver 608 may include a receiving module 612 and a transmitting module 614. The Antenna 610 may be coupled to the transceiver 608 and may be configured to receive and send data wirelessly. In some embodiments the receiving module 612 and the transmitting module 614 are independent entities. The interface module 602 may be coupled to the base station control module 604 and may include hardware and/or software for receiving content data, such as for example, a macro-diversity region defined by the macro-diversity region control module 150 described above, and building a data frame including the received macro-diversity region. Transceiver 608 may include hardware and/or software for transmitting and/or receiving data, such as, for example, the built data frames, which may include MAC management messages, content data, etc.

In one embodiment the receiving module 602 may be configured to receive a macro-diversity region message that includes macro-diversity region data having at least one packet of content data and macro diversity region control information from a central entity such as a macro-diversity region control module 150. In some embodiments, the transmitting module 614 may be configured to transmit the base station transmission frame in synchronization with the transmission of the base station transmission frames of other base stations in the network in response to at least a portion of the macro-diversity region control information received by each of the base stations. In one embodiment the base stations 130 receives UTC time from a global positioning system. (GPS).

The base station control module 604 may be coupled to the transceiver 608 and may be configured for building a data frame comprising a downlink region and macro-diversity region, such as macro-diversity region 240 and map 242 that were discussed above with reference to FIG. 2. The base station control module 604 may further be configured for managing the synchronous transmission of the macro-diversity region by the base station 130 such that the macro-diversity regions transmitted by the base stations 130 in the network 100 are synchronously transmitted by the base stations 130.

The storage device 606 may be coupled to the base station control module 604 to store data received at the base station 130. Storage 606 may include volatile and/or non-volatile storage, for example, read only memory (ROM), non-volatile random access memory (NVRAM), etc. along with one or more volatile storage devices, such as, random access memory (RAM). Storage 606 may be used to store, for example, information for use by the base station control module 604 in building the data frames.

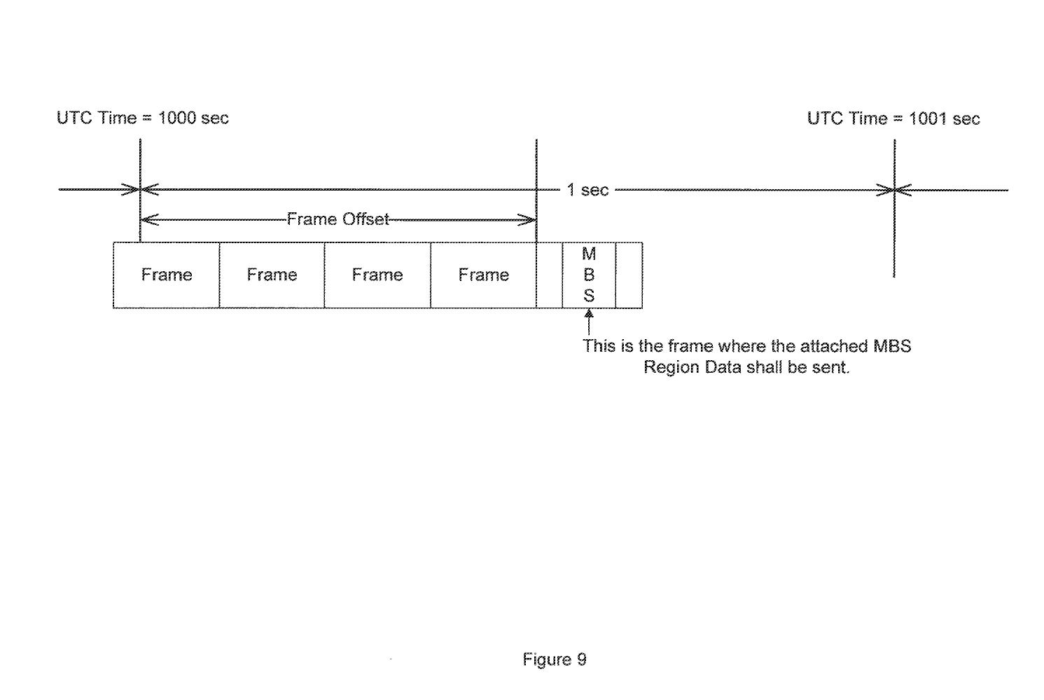

FIG. 9 is an example illustration of base station synchronization using a time reference and frame offset. To achieve macro diversity, the macro-diversity region and it's parameters should be synchronized across all the base stations 130 within a SFN, for example. To achieve this synchronization, macro-diversity region control information (control information) about macro-diversity region parameters may be distributed to all the base stations from a central entity, such as the macro-diversity region control module 150. The control information that is generated by the macro-diversity region control module 150 may include time reference and frame offset information to indicate an offset from the time reference and to further indicate a base station transmission frame that will include a macro-diversity region data. The macro-diversity region data may be included in a macro-diversity region frame generated by the macro-diversity region control module 150. The macro-diversity region frame is built in the macro-diversity region control module core 308.

Each macro-diversity region frame is time-stamped by the MBS core before being sent to the MRDP-MBSC and subsequently to a plurality of base stations 130. In one embodiment the time stamp of each macro-diversity frame includes a time reference and a frame offset from the time reference. The frame offset can be expressed as a number of frames after (or before) the time reference. Thus the combination of the time reference and the frame offset of each macro-diversity frame identifies the base station transmission frame that will include the macro-diversity region data for each of the base stations 130. In one embodiment the time reference is expressed as a UTC time. The macro-diversity region control module 150 or MBS Controller (MBSC) may obtain the UTC time from a GPS driven Network Time Protocol (NTP) Server, for example. The timestamp may be 32 bit number, for example, and may specify the time in seconds. In some embodiments the timestamp may be a 64 bit number including 32 bits specifying the seconds and the other 32 bits specify the fraction of the second. For example, if the time is 1000 seconds with a frame offset of 4, the base station transmission frame is the fourth frame that occurs after the time of 1000 sec.

In one embodiment the macro-diversity region control module 150 may be part of, for example, the ASN Gateway 120, or a Network Manager, or other entity. The choice of the entity on which this functionality resides may vary depending on, for example the infrastructure vendor. In addition, the functionality may be distributed across multiple entities.

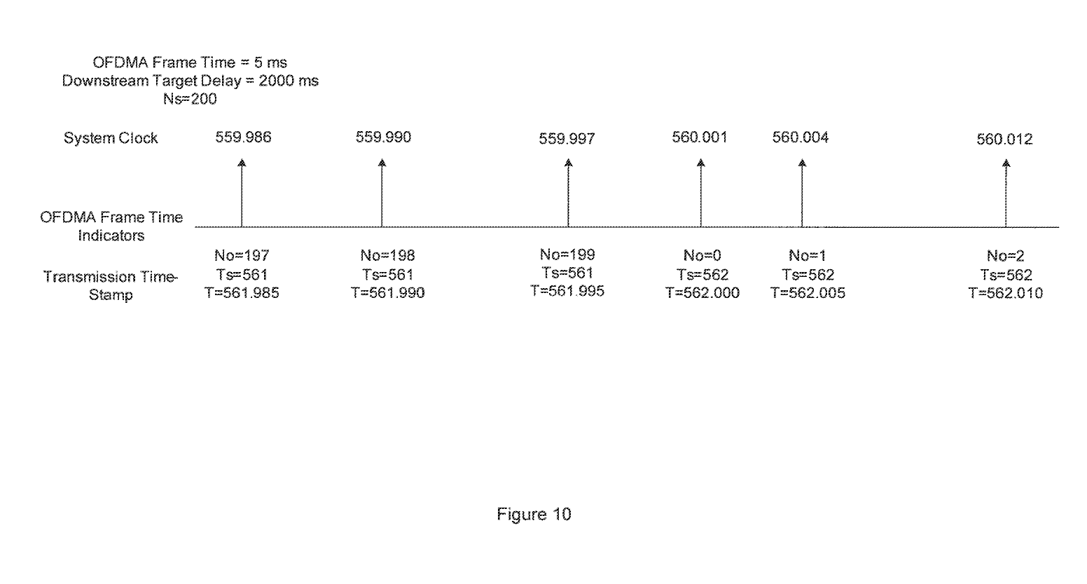

FIG. 10 is one example illustration of the relationship of a time reference, frame offset information and system clock according to an embodiment. Each macro-diversity region frame generated by the macro-diversity region control module 150 may be time-stamped before being sent to MRDP-MBSC. The time-stamp of each frame will indicate the actual time the base station transmission frame from each base station receiving the macro-diversity region frame will be transmitted over the air. The time-stamps may include a time reference, for example, UTC time in seconds and a frame offset from the UTC time. The total number of frames in each second Nₛ may be computed using:

$${N}_{s} = \frac{1 \text{,} 000}{frame time}$$

where the frame time in milliseconds may be specified in the active profile. The time-stamping process may maintain its accuracy by an NTP system, for example, keeping track of the UTC time by measuring and adjusting for the time drift as a result of a mismatch of the frequency of the local oscillator of the macro-diversity region control module 150. Referring back to FIGS. 1 and 3 the NTP system may be executed by the macro-diversity region control module core 308 as well as on each base station 130.

The time stamping procedure may be initiated, for example, when the first frame built by the macro-diversity region control module 150 is ready for delivery to MRDP-MBSC. The macro-diversity region control module 150 reads the UTC, for example, that may include a “seconds” portion and a “fraction of a second” portion. In some embodiments, downstream target delay may be added to this time. The resulting time may be specified in the time-stamp format, for example, the “seconds” portion may form the “seconds” portion of the time-stamp which may be referred to as the time reference and the “fraction of seconds” portion may be converted to frame offset by

$${N}_{0} = ⌊ \frac{1 \text{,} 000 \times fraction of second}{frame time} ⌋$$

where frame time is in milliseconds and No is a frame indicator.

The macro-diversity region control module 150 may generate a frame indicator for every frame time. Note that all frame indicators are not necessarily accompanied with a macro-diversity region frame. However the frame time may have some jitter due to the fact that the macro-diversity region control module 150 performs other tasks as well as scheduling the frames. In one embodiment, every time that a frame indicator is generated, a time stamp counter, for example, advances by one until Nₒ=Nₛ−1 after which the next indicator Nₒ will be set to zero and the seconds part of the time stamp increments by one. Assuming that the frame time is 5 milliseconds and hence Nₛ=200 and that the system time at the beginning is 559.986 and the downstream target delay is 2000 ms. Hence the estimate of transmission time is 561.986 and the transmission time stamp will be Tₛ=561 and the fraction time of 0.986 translates to frame offset Nₒ=197 at the beginning of the process. This translates to actual transmission time of T=T=561.985. The next frame indicator will have Nₒ=198 and the third will have Nₒ=199. The fourth Frame indicator will have a transmission time stamp Tₛ=562 and Nₒ will reset to Nₒ=0.

The incrementing of the frame indicator may be performed even if the macro-diversity region in a frame is empty. The macro-diversity region control module 150 may measure the difference between the frame transmission time stamp and local system clock on a per frame basis in order to verify that the system clock does not considerably deviate from the UTC time. If this difference deviates by more than a threshold number, for example 5%, an (Time Drift) alarm may be generated. In the example, this difference at the beginning is 1999 ms and by the end of the sixth frame it decreases to 1998 ms.

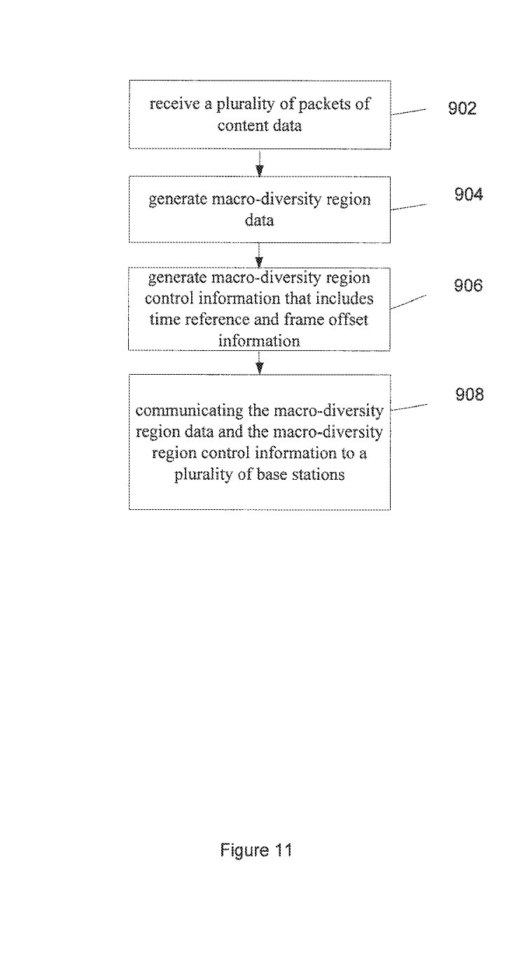

FIG. 11 is an example of a method of synchronizing a macro-diversity region transmitted by a base station in a network according to an embodiment. The steps of this method may be implemented in the macro-diversity region control module 150 illustrated in FIG. 1. At step 902 the procedure starts with receiving a plurality of packets of content data such as ASP 160 of FIG. 1. Content providers or content sources may provide the packets of content data. The content distributed by the content providers may be various forms of audio, video, multimedia and other forms of content including audio/video streams, motion picture expert group-2 (MPEG-2), MPEG-4, windows media video (WMV) etc. In step 904 macro-diversity region data is generated at the macro-diversity region control module, for example. The macro-diversity region data may include at least one packet of the plurality of packets of content data received.

The process then continues to step 906 where macro-diversity region control information is generated. The macro-diversity region control information may include a time reference and frame offset information to indicate an offset from the time reference and to further indicate a base station transmission frame that will include the macro-diversity region data at the plurality of base stations. The time reference information may be expressed in UTC time and may be received from a NTP system as described above with reference to FIG. 10. The time reference and the frame offset information are configured to periodically synchronize the transmission of the macro diversity region data at the plurality of base stations.

Finally, in step 908, a macro-diversity region message that includes the macro-diversity region data and the macro-diversity region control information is communicated to a plurality of base stations as was described above with reference to FIG. 8. The macro-diversity region control information may also include a symbol offset to indicate an offset from the start of the base station transmission frame to identify the location for the macro-diversity region data in the base station transmission frame.

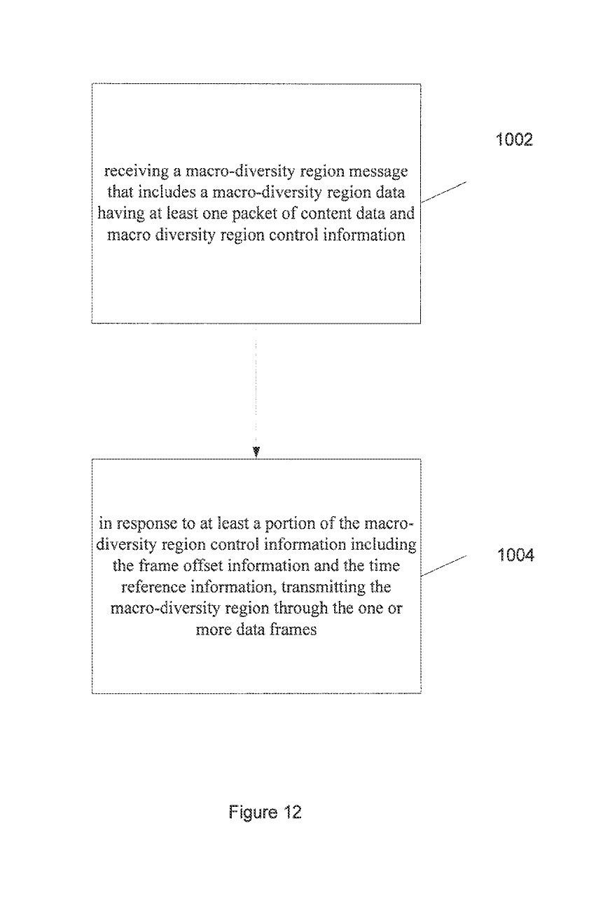

FIG. 12 is an example method of synchronizing macro-diversity regions transmitted by the plurality of base stations in a network according to an embodiment utilizing the methods and processes described above. The steps of this method may be implemented in each of the plurality of base stations 130 illustrated in FIG. 1. In one embodiment the process is implemented by the base station control module 604. At step 1002 the process starts with the base station receiving a macro-diversity region message that includes macro-diversity region data having at least one packet of content data and macro diversity region control information. The macro-diversity region message may originate from a central entity, for example, the macro-diversity region control module 150 described with reference to FIG. 1. The macro-diversity region control information may include a time reference and frame offset information to indicate an offset from the time reference and to further indicate a base station transmission frame that will include the macro-diversity region data as was described above with reference to FIG. 7. The process then continues to step 1004, each of the plurality of base stations transmit in synchronization the macro-diversity region data in the identified base station transmission frame according to the time reference and the frame offset information.

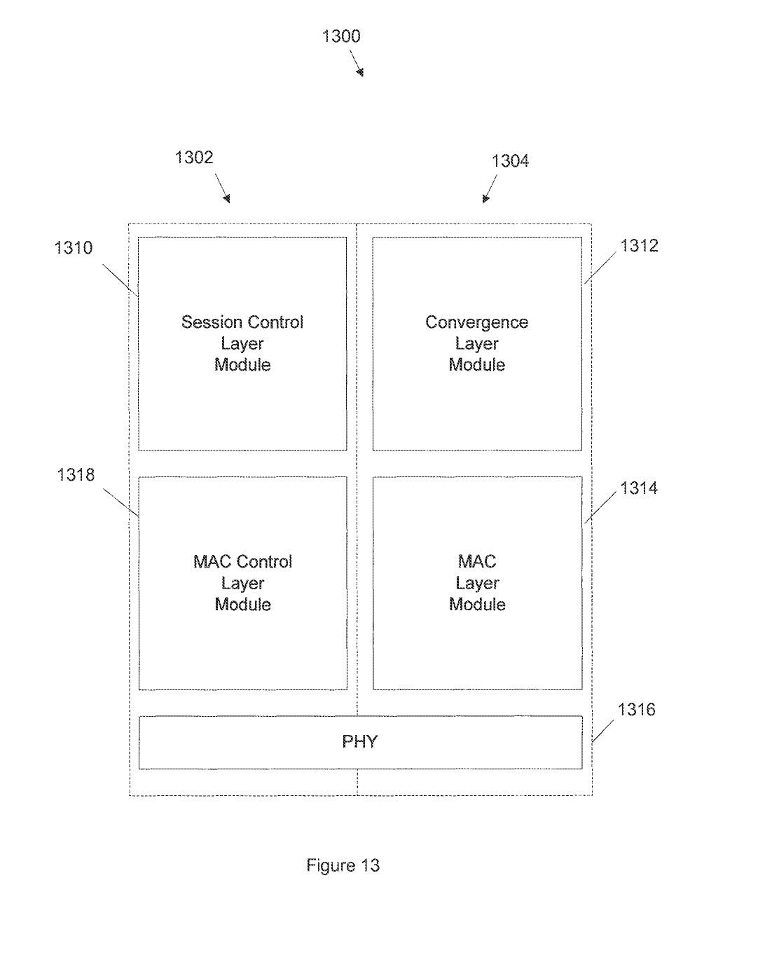

FIG. 13 provides a diagram illustrating a layering model that performs processes in accordance with various protocol modules to implement an example embodiment. One or more instances of each illustrated protocol module may exist on each side, transmit and receive, of a wireless air interface link. That is, for example, this layering model may be implemented by software stored in the memory of and executed by one or more processors included in each BTS 130 and the macro-diversity region control module 150 as well as in each client station 132.

These protocol modules are grouped into two distinct types: bearer protocol modules 1302, and non-bearer protocol modules 1304. A bearer protocol module includes a protocol that is involved with the transmission/reception of content (payload) data across the air interface, and a non-bearer protocol module includes a protocol that is involved with the transmission/reception of control messages or overhead messages across the air interface. The layers are also referred to as bearer and non-bearer layers, depending on the types of protocol modules associated with the respective layer. Bearer and non-bearer protocol modules can be implemented on both the receive side and the transmit side, of the broadcast system.

As shown in FIG. 13, the layering model 1300 may include a session control layer module 1310, a convergence layer module 1312, a MAC layer module 1314, and a MAC control layer module 1318, and a physical (phy) layer 1316. In one embodiment, the session control layer module 1310 provides system configuration and state maintenance. Typically the session control layer module 1310 includes non-bearer protocols, and so does not carry payloads on behalf of other protocols. Although illustrated in FIG. 13, in the presently described embodiment, there may be no protocols defined for the session control layer module 1310 as the presently described embodiment is described with reference to a broadcast system and as such there need not be a mutual state held at both the client stations 132 and BTSs 130.

The convergence layer module 1312, in one embodiment, provides a conduit for upper layer protocols/applications to transport their data over a media access control (MAC) layer module 1314 described further below. In general, the convergence layer module 1312 defines protocols, interfaces, encapsulations and mappings to accommodate and interface to upper layers. In one embodiment, the convergence layer module 1312 implements a Digital Video Broadcast-Handheld (DVB-H) Motion Picture Expert Group-2 (MPEG-2) Transport Stream Convergence Protocol (TSCP) to efficiently map DVB-H MPEG-2 Transport Stream packets for transport as MAC service data units (SDUs).

The MAC layer module 1314 on the transmit side (e.g. in the macro-diversity region control module 150) includes a scheduler that can receive MAC service data units (SDUs) from an upper layer regarding filling physical layer (PHY) allocations with data. The MAC layer module 1314 can also define burst allocations which, given the size of a macro-diversity region of a data frame, determine the size (including the OFDMA dimensions) and location of data bursts allocated within the macro-diversity region of an OFDMA frame.

The MAC layer module 1312 can also include bearer protocols for processing MAC protocol data units (PDUs) for use with a physical layer 1316. In one embodiment, the MAC layer module 1314 includes a shared signaling MAC protocol that transmits (in a BTS) or receives (in a client station) shared signaling control PDUs. At a BTS, the shared signaling MAC protocol maps shared signaling control PDUs, such as the macro-diversity region MAP and MAC management PDUs, to the physical layer 1316 channel. The MAC layer module 1314 also includes a Traffic Channel MAC protocol that places and extracts MAC PDUs to and from the physical layer 1316 channel. In an embodiment employing WIMAX, the MAC layer module 134 may comprise a MAC Common Part Sublayer (MCPS) in accordance with the IEEE 802.16 specification.

The layering model of FIG. 13 includes a MAC Control layer module 1318. The MAC Control layer module 1318 establishes an air link between a BTS and a client station. The MAC Control layer module 1318 may further manages an overall state machine which determines the state of the macro-diversity region air link. The MAC Control layer module 1318 also manages network initialization. Further, the MAC control layer module 1318 may be responsible for building and transmitting management messages, such as, for example, a MAC management message identifying the content data included in the macro-diversity region of a data frame. A further description of exemplary management messages for identifying content data in a macro-diversity region is presented below.

In FIG. 13, the Physical layer 1316 provides physical layer transport for air link messages, such as for example, forming the waveform on the transmit side for transmitting the content data or reforming PDUs from a received waveform on the receive side.

As noted above, in an embodiment, the BTSs may broadcast a MAC management message to the client stations that identifies the content data included in the macro-diversity region. In one embodiment, this MAC management message may be a Service Identity Information-Advertise (SII-ADV) MAC management message, such as described in the IEEE 802.16e. Further, in one embodiment, a Type/Length/Value element may be included within the SII-ADV message that may be used to carry broadcast connection identifier (CID) information for content data included in the macro-diversity, or broadcast, region of the data frame. In addition, the TLV can include information about the services available in the macro-diversity region, as will be discussed in further detail below. This MAC management message may be broadcast periodically without solicitation, or, for example, a client station may request that the message be transmitted.

Table 1 below shows one example of an exemplary SII-ADV message, in accordance with IEEE 802.16e, that may be used as a MAC management message for identifying content data to client stations.

TABLE 1

| Field | Length | Notes |
|---|---|---|
| Management | 8 bits | Set to a value of 68 in accordance with IEEE |
| Message Type | | 802.15 Standard |
| NSP List TLV | 3 * bytes | If present, this lists the NSPs associated with the |
| | | SP providing the content data corresponding to a |
| | | particular broadcast CID. This TLV includes a 24- |
| | | bit NSP identification for each associated NSP. |
| NSP Change Count | 1 byte | If present, this lists the NSP list previously |
| TLV | | announced by the NSP List TLV. For example, |
| | | increment by one (modulo 256) whenever the list |
| | | of the NSPs changes. |
| Broadcast Service | 4 * n | This lists the Broadcast Services available within |
| Announcement TLV | bytes | the macro-diversity region. This TLV may be |
| | | present in every SII-ADV message by a BTS. Each |
| | | broadcast service tag comprises a 16-bit broadcast |
| | | CID and a 16-bit broadcast type. |

As shown in the example of Table 1, the SII-ADV message includes multiple fields. A first field, referred to as the “management message type,” is used to identify what type of MAC management message the message is and in this example the value is set to 68 to identify the message as an SII-ADV message, as per IEEE 802.16e.

The second field in this exemplary SII-ADV message is referred to as the “network service provider (NSP) list TLV,” and is optional in this example. If present, this field lists the NSPs associated with the ASP providing the content data. For example, as noted above, in an embodiment, a particular ASP may be connected to multiple broadcast service networks, each operated by a different NSP, for broadcasting the content data to the client stations via one or more ASNs. In this example, the NSP list TLV field includes a 24-bit NSP identification for identifying each NSP associated with the ASP. As such, the size of this field is dependent on the number of associated NSPs (i.e., the field size is three bytes in length per the number of NSPs). Further, in embodiments, in which the ASP and NSP functions are combined in a single service provider, this field may not be included.

A third field in this exemplary SII-ADV message is referred to as the “NSP change count TLV.” This field is optional and in embodiments may not always be present. The field simply counts the number of changes in the NSP list TLV and is incremented by one every time the NSP list TLV changes. In one embodiment, if present, the NSP change count TLV is one byte in length and increments by one (modulo 256) whenever the list of the NSPs changes.

A fourth field in the SII-ADV message is referred to as the “broadcast service announcement TLV.” This TLV, in the present example, lists the broadcast services available within the macro-diversity region of a frame. In the present example, a broadcast service announcement TLV is included in the SII-ADV message for each broadcast service available in the macro-diversity region. In the present embodiment, each broadcast service announcement TLV comprises a 2 byte long broadcast CID and a 2 byte broadcast service type identifier, for a total length of 4 bytes times the number of services available.

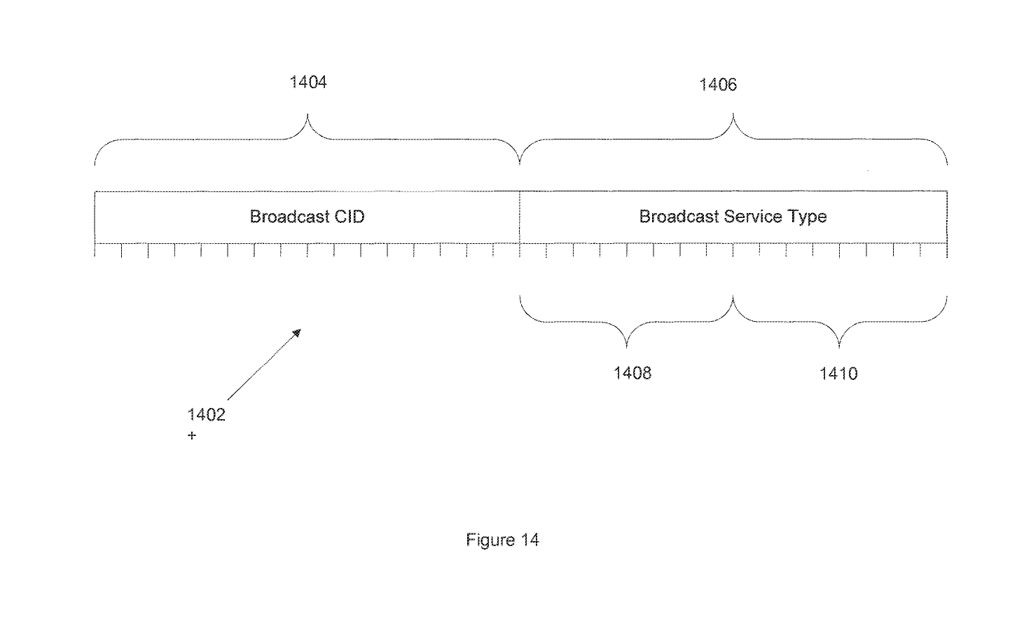

FIG. 14 is a diagram illustrating an example embodiment of a broadcast service announcement TLV (also referred to herein as a broadcast service tag). As shown in FIG. 14, a broadcast service tag 1402 may include, for example, two sixteen (16) bit fields 1404 and 1406. The first field 1404 is a broadcast service CID field that includes the broadcast CID for the associated broadcast service. The second field 1406 is a broadcast service type field. In an embodiment, the broadcast service type field 1406 includes two subfields, an encoding profile field 1408 and a service profile field 1410. The encoding profile field 1408 includes information about characteristics of the encoded data of the service. For example, the encoding profile can include information about the associated broadcast service, such as, the type of encoding used (MPEG, WMAV, etc.), the encoding rate, the frame rate, and the resolution used in encoding the content data for the broadcast service. In one embodiment, the resolution can be used by a client station to identify a type of client device that can access the service. For example, some client devices, such as a cellular phone, or a PDA may not be able to access services at a particular resolution while another client device, such as a laptop computer, may be able to access services at that particular resolution.

The service profile field 1410 includes information identifying the channels of the broadcast service available in the macro-diversity region, such as, for example, television broadcast stations, such as ABC, or NBC, included in the macro-diversity region. For example, the service profile field 1410 may include an individual identifier (e.g., an encoded textual entry) identifying each available content channel. In still another embodiment, the service profile field 1410 includes information identifying an individual piece of content in the macro-diversity region, such as for example, the evening news on ABC. In other embodiments combinations of information identifying the service can be used.

In yet another embodiment, the broadcast service type field 1406 may be used to store a profile number that corresponds to a particular broadcast service type. For example, a particular profile number may be used to both identify the type of channel encoding used for the broadcast service (e.g., MPEG at a particular resolution) and the channels included in the broadcast service (e.g., CNN, Fox News, ESPN, etc.). That is, for example, one profile number may be used to identify a group of channels encoded using MPEG with a low resolution for display on cell phones, a different profile number may be used to identify the same group of channels but encoded with a higher resolution for display on a television, yet a different number may be used to identify a different group of channels encoded with a particular resolution, and so on. Or, for example, in an embodiment using an encoding profile field and a service profile field, one or both of these fields may use a profile number to identify a particular subset of properties (e.g., the type of encoding, and the available content channels, respectively) for the broadcast service.

A client station can decode a received SII-ADV message and determine, based on information in the message, if there is content data of interest in the macro-diversity region. If there is content data of interest, then the client station can decode the macro-diversity region and use the included macro-diversity map to retrieve the desired content data from the macro-diversity region. If it is determined that there are no broadcast services of interest, or no broadcast services that the client station can decode, then the client station can ignore, and not decode the macro-diversity region. In this way the client station can conserve resources.

In an embodiment, the client station determine whether there is content data of interest in the macro-diversity region by examining the broadcast CID included in the broadcast service tag of the received SII-ADV message. If this broadcast CID matches a broadcast CID stored by the client station (e.g., the client station subscribes to the broadcast service identified by the stored broadcast CID) then the client station can decode the macro-diversity region and retrieve the content data of interest to the client station.

In another embodiment, even if the broadcast CID doesn't correspond to a broadcast service to which the client station subscribes, the client station may examine the broadcast service type field 1406 to determine whether the macro-diversity region includes content data of interest to the client station that is encoded using an encoding scheme and resolution supported by the client station. For example, if the client station desires to receive CNN but the client station does not receive a signal including a message including a broadcast CID for a broadcast service to which the client station subscribes, the client station may examine the broadcast service type field 1406 to see if CNN is included in the macro-diversity region as well as to see if the client station supports the encoding scheme used for encoding the CNN channel. If the desired content is present and encoded using a supported encoding scheme, the client station may then decode and retrieve the content data of interest to the client station from the macro-diversity region. Further, in such an embodiment, prior to retrieving the content data from the macro-diversity region, the client station may display a question asking whether the user wishes to retrieve the content data from the broadcast service along with a cost to the user, if any, if the user elects to retrieve the content data. In such an example, if the user elects to receive the content data, a MAC management message may be sent from the client station including information regarding the client station that can be forwarded to the ASP for billing purposes. It should be noted that these are but examples of how a client station may use the information in the broadcast service tag 1402 to determine whether or not to decode and retrieve content data from the macro-diversity region.

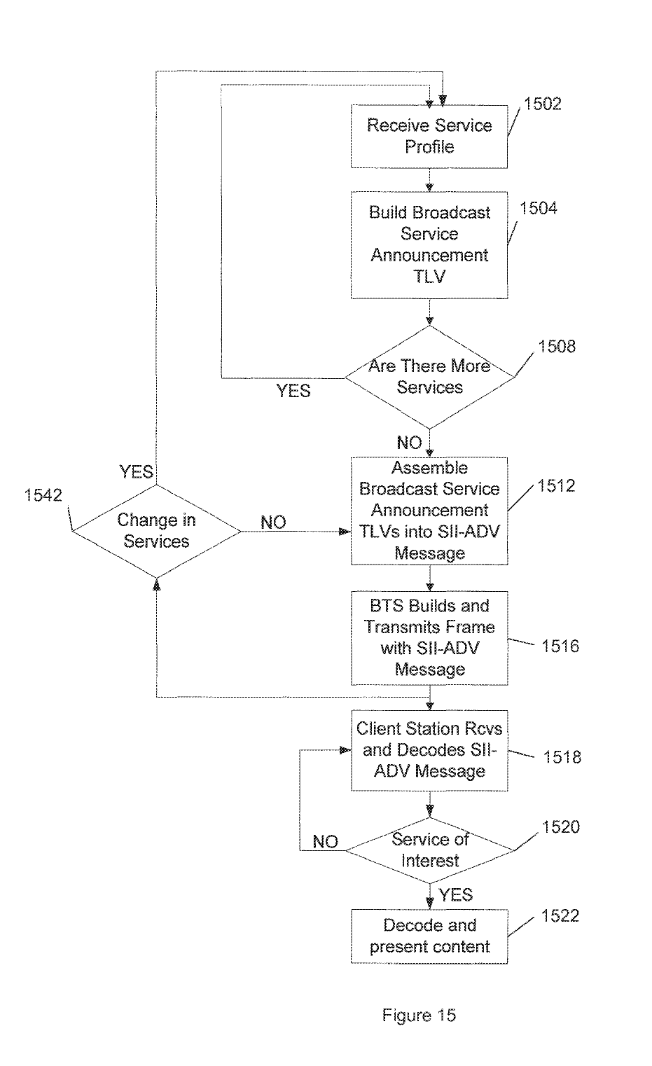

FIG. 15 is a flow chart of an example embodiment of building a management message for identifying content data available in a macro-diversity region of a data frame. For exemplary purposes, FIG. 15 will be described with reference to a management message that is an SII-ADV message including a broadcast service tag, such as illustrated in FIG. 14. FIG. 15 will further be described with reference to the above-discussed FIG. 1. Flow begins in block 1502 where a BTS 130 receives, a service profile of a broadcast service that is to be provided in a macro-diversity region of a data frame transmitted by the BTS 130. For example, the service profile for the broadcast service can include the broadcast CID for the broadcast service, the encoding type and resolution used for encoding the content data, the type of service, such as broadcast television service, or pay-per-view service, and information identifying particular services such as a particular television broadcast station provided in the broadcast service. In still another embodiment, the service profile can include information identifying an individual piece or pieces of content in the macro-diversity region such as a particular television show that is being broadcast.

Further, as noted above, in an embodiment, the broadcast service type may be identified by a service profile number that a client station may look up in a table to identify the channels of content data as well as information regarding the encoding scheme and resolution used in encoding the content data. As such, in such an example, the service profile received by the BTS 130 may include the broadcast CID as well as the service profile number for the broadcast service. This service profile may be, for example, provided by the ASP 160 which may, for example, use a management messaging scheme for communicating a management message including the service profile to, for example, the ASN Gateway 120, which then distributes the service profile to the BTSs 130. In an embodiment, this management message may be provided by the ASP 160 to an element manager (not shown) included in the ASN 105, which then provides the management message to the ASN Gateway 120, or, for example, directly to the BTSs 130. Or, in, for example, embodiments in which only one broadcast service is included in the macro-diversity region defined by the macro-diversity region control module 150, the service profile may be stored by the ASN Gateway 120 or BTSs 130, such as, for example, during set-up and provisioning of the ASN Gateway 120 or BTSs 130, respectively.

Flow then continues to block 1504 where a MAC control layer module executing in the BTSs 130 builds a broadcast service tag, such as described above with reference to FIG. 4. In block 1510, the MAC control layer module then determines if there are more broadcast services included in the macro-diversity region provided to the BTS 130 by the macro-diversity region control module 150. If there are additional broadcast services, flow continues to block 1502 and the service profile is retrieved or obtained, such as described above, for the next broadcast service include in the macro-diversity region. Then, a new broadcast service tag 402 is determined for this broadcast service. In block 1510 if it is determined there are no additional services to announce as included in the macro-diversity region, flow continues to block 1512. In block 1512, the BTS 130 assembles the broadcast service announcement TLV's into an SII-ADV message, such as discussed above with reference to Table 1. As discussed above, in an embodiment, the macro-diversity region control module 150 defines the macro-diversity region comprising the content data and provides the defined macro-diversity region to the BTSs 130 for inclusion in the data frames built by the BTSs 130. This building of the macro-diversity region and providing of same to the BTSs 130 may be performed concurrent with the BTSs 130 building the SII-ADV message.

The BTSs 130 then in block 1516 may each assemble a data frame, such as data frame 202 of FIG. 2, that the BTSs 130 transmit to the client stations 132. As discussed above, in an embodiment, the SII-ADV message is a MAC management message, and as such, in an embodiment, is transmitted by the BTSs 130 in the downlink data region 236 of the data frame 202 while the content data is included in the macro-diversity region 240 of the data frame 202. Further, as noted above, the BTSs 130 may use different modulation and encoding schemes for transmitting the different regions of the frame 202. For example, in an embodiment the BTSs 130 may transmit the downlink region 236 using QPSK while the BTSs 130 transmit the macro-diversity region 240 using 64 QAM. Further, in an embodiment, the BTSs 130 each synchronously transmit the macro-diversity region using the same modulation and coding scheme. The BTSs 130, however, may each use different modulation and coding schemes for transmitting the individual downlink regions 236 included in the frames transmitted by each BTS 130.

As noted above, in an embodiment, the BTSs 130 may periodically broadcast the SII-ADV message. For example, the BTSs 130 may periodically broadcast the SII-ADV message to the client stations 132, such as, for example, in every frame, every other frame, every fourth frame, and so on, transmitted by the BTSs 130. Further, if after building and transmitting the SII-ADV message, the BTSs 130 receives a new or modified service profile in block 1542, the process may return to block 1502 and build a new or modify an existing broadcast service announcement TLV.

The data frame broadcasted by the BTSs 130 is then at block 1518 received by a client station 132, which decodes the downlink data region 236 and retrieves the SII-ADV message. The client station 132 then determines in block 1520 whether the SII-ADV message indicates that macro-diversity region 240 of the frame 202 includes content of interest to the client station 132. The client station 132 may determine this by retrieving the broadcast service tags 1402 from the SII-ADV message and examining them to see if there is a broadcast service tag 1402 including a broadcast CID identifying a broadcasting service including the content of interest to client station 132. Further, the client station 132 may also examine the broadcast service type field 1406 in determining if the content of interest is available in the macro-diversity region 240 and is encoded in a manner supported by the client station 132.

For example, if a client station 132 subscribes to a broadcast service identified by a particular broadcast CID, and the user of the client station 132 wishes to view a particular channel (e.g., CNN), the client station 132 may first examine the broadcast CIDs in the SII-ADV message to see if it includes the broadcast CID for the broadcast service to which the client station subscribes. If so, the client station may then examine the broadcast service type field 1406 to determine whether the broadcasted content includes the desired channel and that the desired channel is encoded in a manner supported by the client station. For example, if the client station is a cell phone, it may only be able to decode and display content data encoded using MPEG with a low resolution.

Or, for example, in another embodiment, a broadcast CID may be used by the system that both identifies the broadcast service as well as the particular broadcast content and the encoding used. Or, in yet another example, the client station 132 may first look for a broadcast CID in the SII-ADV message corresponding to a broadcast service to which the client station subscribes. If, however, the client station 132 does not locate such a broadcast CID in any received SII-ADV message, the client station 132 may next look at the broadcast service type field 406 to determine if a macro-diversity region includes the content of interest to the client station 132 and whether this content data is encoded in a manner supported by the client station 132. If so, the client station 132 may retrieve, decode, and present the desired content data to the user. Further, in such an example, the client station 132 may first inquire from the user whether the client station 132 should retrieve and decode the content data as well as the cost to the user, if any, before decoding the content data. And, if the user elects to receive the content data, the client station 132 may transmit a message indicating such to the BTSs 130, such that billing information for the client station 132 may be forwarded to the ASP 160 for appropriately billing the user.

If the client station 132 determines that the macro-diversity region 240 includes content of interest to the user, the client station may then decode the macro-diversity region 240 and present the content data to the user at block 1522. As noted above, the macro-diversity region 240 may use a different modulation and coding scheme than the downlink region 236. If the client station 132, however, determines that the macro-diversity region 240 does not include content of interest to the client station 132, the client station 132 returns to block 1518 and continues to examine received SII-ADV messages looking for a BTS 130 transmitting a macro-diversity region 240 comprising the content desired by the client station.

Although FIG. 15 was discussed with reference to the BTS 130 building the broadcast service tags and SII-ADV messages, in other embodiments these entities may be built by different elements. For example, in an embodiment, the macro-diversity region controller 150 or ASP 160 may be responsible for building these entities and providing them to BTSs 130 for transmission by the BTSs 130 in the downlink region of the data frame.

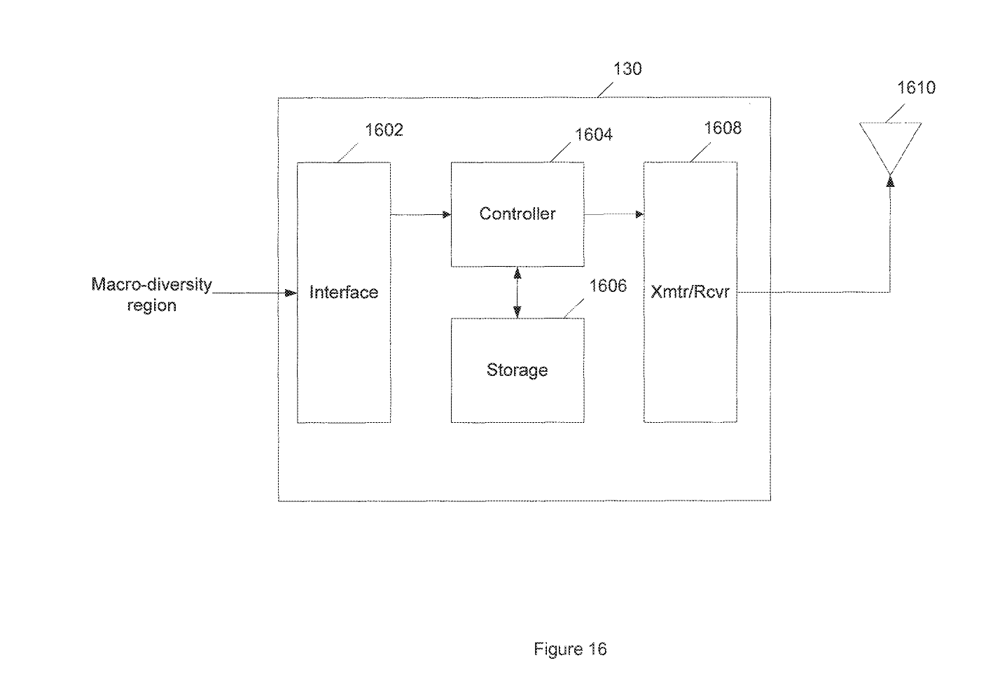

FIG. 16 is a block diagram illustrating a simplified exemplary embodiment of a BTS. For explanatory purposes, FIG. 16 will be discussed with reference to the above-discussed FIG. 1. As illustrated, BTS 130 may comprise a first interface 1602, controller 1604, a storage device 1606, a transceiver 1608, and an antenna 1610. Interface 1602 may comprise hardware and/or software for receiving content data, such as for example, a macro-diversity region defined by the macro-diversity region control module 150 and a service profile provide by ASP 160. Transceiver 1608 may comprise hardware and/or software for transmitting and/or receiving data, such as, for example, MAC management messages, content data, etc. For example, as discussed above, in an embodiment utilizing an OFDMA frame in accordance with IEEE 802.16e, the transceiver 1608 may be used to transmit the downlink region and macro-diversity region of the frame and receive the uplink region. Antenna 1610 may for example be any type of antenna, such as those commercially available.

Controller 1604 may, for example, comprise one or more processors configured for generating MAC management messages, such as, for example, the above described SII-ADV message comprising a broadcast service field tag 1402, such as discussed above with reference to FIG. 14. Controller 1604 may further be configured for building a data frame comprising a downlink region and macro-diversity region, such as macro-diversity region 240 and map 242 that were discussed above with reference to FIG. 2. The generated MAC management messages, including the above-described SII-ADV message, may be placed by the controller 1604 in the downlink region for transmission to the client stations 130. Controller 1604 may further be configured for managing the synchronous transmission of the macro-diversity region by the BTS 130 such that the macro-diversity regions transmitted by the BTSs 130 in the network 100 are synchronously transmitted by the BTSs 130 using a common modulation and coding scheme, as discussed above. Further, as noted above, the downlink regions transmitted by the various BTSs 130 in the network 100 may be transmitted using different modulation and coding schemes.

Storage 1606 may comprise volatile and/or non-volatile storage. For example, in an embodiment, storage 1606 may comprise one or more non-volatile storage devices, such as for example, read only memory (ROM), non-volatile random access memory (NVRAM), etc. along with one or more volatile storage devices, such as, for example, random access memory (RAM). Storage 1606 may be used to store, for example, information for use by the controller 1604 in building the data frames. For example, in an embodiment, in which the macro-diversity region control module 150 is only used for transmitting content data belonging to one broadcast service, storage 1606 may store the broadcast CID for this broadcast service as well as, for example, information identifying the type of encoding used to encode the content data as well as information identifying the particular content channels belonging to the broadcast service. As noted above, in an embodiment, the information identifying the encoding used may be a profile number that a client station can look up in a table to determine the encoding protocol used as well other information regarding how the content data was encoded (e.g., the resolution of the content data). Similarly, the information stored by the storage device may comprise a content profile number that a client station may look up in a table stored by the client station to determine, for example, the particular content channels carried in the macro-diversity region of the received data frame.

Further, in an example, in which the macro-diversity region is used to carry content data belonging to multiple broadcast services, controller 1604 may further be used to receive and process management messages received from, for example, the ASP providing the broadcast service. For example, referring back to FIG. 1, ASP 160 may provide management messages including the broadcast CID for the content data it provides as well as information identifying the contents data's encoding and information identifying the particular content data (e.g., content channels) provided by ASP 160 to broadcast service network 115. Controller 1604 may then store this information in storage 1606 and use the received information in generating the management message identifying the content data included in the macro-diversity region.

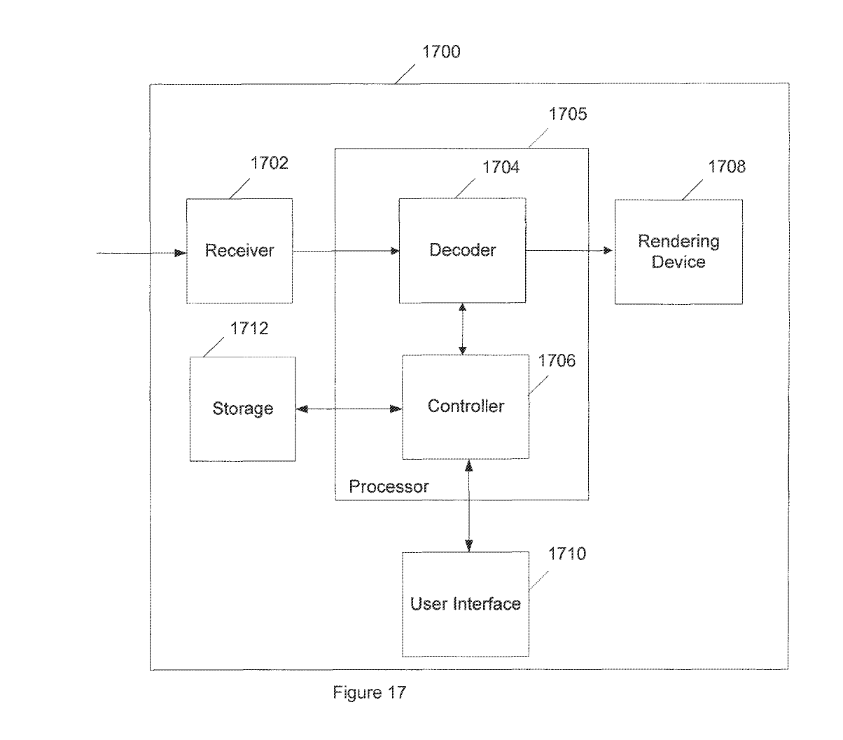

FIG. 17 is a block diagram illustrating an example embodiment of portions of a client station. As shown in the example of FIG. 17, the client station 1700 includes a receiver 1702, a processor 1705, a user interface 1710, and an output device 1708. Rendering device 1708 may be, for example, any device capable of presenting content data to a user, such as for example, a Liquid Crystal Display (LCD), High Definition Television (HDTV), a speaker, etc. User interface 1710 may comprise any device capable of permitting client station 1700 to receive information from a user, such as, for example, a key pad, a key board, a mouse, a touch screen, a microphone, etc.

Storage 1712 may comprise any combination of volatile or non-volatile storage (e.g., RAM, ROM, etc.). Storage 1712 may be used to store information regarding the content of interest to the client device 1700, such as, for example, a broadcast CID of broadcast services to which the client station subscribes, the particular content data (e.g., CNN, EPSN, etc.) the user desires to receive, and the rendering capabilities of the client device 1700 (e.g., what type of encoding the client device 1700 can decode as well as the resolution or other parameters of the rendering device 1708).

In an embodiment, a user may be able to enter information regarding the content of interest to the user using the user interface 1710 that is then stored by controller 1706 in storage 1712. For example, in an embodiment in which rendering device 1708 is a display, rendering device 1708 may present information regarding available broadcast services and its associated content data to the user on the display. The user may then select the particular content of interest to the user using the user interface 1710 that controller 1706 then stores in storage 1712. For example, the user may enter via user interface 1710 information indicating that the user wishes to receive a particular sports channel. The controller 1710 may then store this information in storage 1712. Or, for example, in an embodiment in which client station 1700 includes a transmitter to permit two-way communications, a user using user interface 1710 may communicate with an ASP via a network, such as a WiMax network, to subscribe to a broadcast service provided by the ASP. The ASP may then transmit the broadcast CID for the broadcast service, along with any de-encryption information if, for example, the broadcasted content data is encrypted by the ASP to the client station 1700. The controller 1706 may then store this received information in storage 1712.

The receiver 1702 may include, for example, an antenna as well as hardware and/or software for receiving data transmitted from a BTS and communicating the received data to a processor 1705. The processor 1705 may comprise, for example, a decoder module 1704 responsible for decoding signal received from a BTS and forwarding the decoded signals (e.g., the content data) to a rendering device 1708. The processor may further comprise a controller responsible for management of the client station 1700 such as for example providing MAC management, etc.

In operation, when client station 1700 receives a data frame from a BTS, decoder module 1704 identifies and locates the start of the data frame. Decoder module 1704 then decodes at least a portion of the received data. For example, referring back to the exemplary data frame of FIG. 2, the decoder module 1704 can decode the preamble 208, FCH 210, DL-Map 212, UL-Map 214, and the downlink data region 236.

The controller 1706 may then analyze the decoded data and identify any MAC management messages in the downlink data region 236 for the client station 1700. As noted above, and referring back to Table 1 and FIG. 4, in an embodiment, an SII-ADV message, which has a management message type field with a value of 68, may be used by the system to send information identifying the content data in the macro-diversity region 240 of the data frame 202. The controller 1706 when analyzing the received MAC management messages may determine that a received message is an SII-ADV message for the client station 1700 by analyzing this management message type field.

The controller 1706 may then retrieve the broadcast service tags 402 from the SII-ADV message and examine the information contained therein to determine if there is content data of interest to the client station 1700 in the macro-diversity region 240. For example, the controller 1706 may retrieve the stored information regarding the content of interest from the storage 1712 and compare the information with the information received in the broadcast service tags 402. As noted above, in an embodiment, storage 1712 may store the broadcast CID for the content of interest to the client station. In such an example, the controller 1706 may simply analyze the broadcast CIDs received in the broadcast service tags 402 to determine if there is a match with the stored broadcast CID. Or, for example, the client station may retrieve the information from the storage 1712 regarding the rendering capabilities of the client station 1700 as well as the particular content data or interest to the user (e.g., a sports program). The controller 1706 may then compare this retrieved information with the information in the received broadcast service tags 402 to determine if there is a match (i.e., the macro-diversity region contains both the content channel of interest and that it is encoded in a manner supported by the client station). If so, the controller 1706 may determine that the macro-diversity region contains content of interest to the client station. Further, as was discussed above with reference to block 520 of FIG. 5, the user of the client station 1700 may be asked whether they wish to receive the content data as well as its cost if it is determined that the macro-diversity region contains the content of interest to the user but the user doesn't subscribe to the particular broadcast service being received.

If the controller 1706 determines that there is content data of interest, then the processor 1706 can direct the decoder module 1704 to decode the macro-diversity region of the received data and provide the decoded content data for the desired content to the rendering device 1708 for presentation to a user. If there is, however, no content data of interest, or the characteristics of the services indicate that the service can not be decoded by the client station, the processor 1706 can direct the decoder module 1704 to not decode the macro-diversity region of the received data, thereby conserve resources, such as power, in the client station.

Although processor 1705 was illustrated as a single device comprising separate software modules, it should be noted that in other embodiments, processor 1705 may comprise a plurality of hardware devices (e.g., ASICs, DSPs, etc.) and/or software modules configured to operate in a manner such as described above. For example, in an embodiment, the decoder 1704 and controller 1706 of processor 1705 may be performed by separate pieces of hardware or they may be combined on a single piece of hardware.

Various implementations of the disclosure are realized in electronic hardware, computer software, or combinations of these technologies. Some implementations include one or more computer programs executed by one or more computing devices. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., interfaces, mice, and keyboards), and one or more output devices (e.g., display consoles and printers).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Various illustrative implementations have been described. However, one of ordinary skill in the art will see that additional implementations are also possible and within the scope of the present disclosure.

Accordingly, the present disclosure is not limited to only those implementations described above. Those of skill in the art will appreciate that the various illustrative modules and method steps described in connection with the above described figures and the implementations disclosed herein may often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the disclosure. In addition, the grouping of functions within a module or step is for ease of description. Specific functions may be moved from one module or step to another without departing from the disclosure.

Moreover, the various illustrative modules and method steps described in connection with the implementations disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium including a network storage medium. An exemplary storage medium may be coupled to the processor such that the processor may read information from, and write information to, the storage medium. In the alternative, the storage medium may be integral to the processor. The processor and the storage medium may also reside in an ASIC.

The above description of the disclosed implementations is provided to enable any person skilled in the art to make or use the subject matter disclosed. Various modifications to these implementations will be readily apparent to those skilled in the art, and the generic principles described herein may be applied to other implementations without departing from the spirit or scope of the disclosure. Thus, it is to be understood that the description and drawings presented herein represent example implementations and are therefore representative of the subject matter which is broadly contemplated by the present disclosure. It is further understood that the scope of the present disclosure fully encompasses other implementations and that the scope of the present disclosure is accordingly limited by nothing other than the appended claims.

What is claimed is:

1. A method of generating and synchronizing a macro-diversity region transmitted by base stations in a network comprising:
receiving a plurality of packets of content data;
generating macro-diversity region data that includes at least one packet of the plurality of packets of content data;
generating macro-diversity region control information that includes a time reference and frame offset information to indicate an offset from the time reference to identify a base station transmission frame that will include the macro-diversity region data; and
communicating the macro-diversity region data and the macro-diversity region control information to a plurality of base stations, the macro-diversity region control information including the time reference and the frame offset information to identify the base station transmission frame to include macro-diversity region data and to synchronize the transmission of the macro-diversity region data at the plurality of base stations.
